(19) United States
(12) Patent Application Publication
(10) Pub. No.: US 2009/0215306 A1
(43) Pub. Date: Aug. 27, 2009

(54) ELECTRICAL CONNECTOR WITH COMPRESSION GORES

(75) Inventor: Rip HANKS, Gulf Breeze, FL (US)

Correspondence Address: Momkus McCluskey, LLC, 1001 Warrenville Road, Suite 500, Lisle, IL, 60532, US

(73) Assignee: CENTERPIN TECHNOLOGY, INC., Gulf Breeze, FL (US)

(21) Appl. No.: 12/434,292

(22) Filed: May 1, 2009

Related U.S. Application Data
(63) Continuation-in-part of application No. 12/126,699, filed on May 23, 2008.
Application No. 12/126,699 is a continuation-in-part of application No. 11/737,495, filed on Apr. 19, 2007, now Pat. No. 7,520,772.
Application No. 11/737,495 is a continuation-in-part of application No. 11/420,646, filed on May 26, 2006, now Pat. No. 7,226,308.

(51) Int. Cl. H01R 4/26; H01R 4/24

(52) U.S. Cl. 439/427; 439/394

(57) ABSTRACT

An electrical connector has a body with a bore that terminates in a sloped surface at its inner end. A cap, through which a conductor is threaded, fits into the bore. An axial inner end of the cap is divided into a plurality of spaced-apart gores which, when the cap is forced axially inwardly, will cam against the sloped surface in the bore, displacing the gores toward the axis and gripping and fastening in place the electrical conductor. Preferably the gores have ridges on their internal surfaces and a center pin standing up from the bottom of the bore has grooves mating with some of these ridges.

### RELATED APPLICATIONS

This application is a continuation in part of copending U.S. patent application Ser. No. 12/126,699 filed 23 May 2008, which in turn is a continuation in part of U.S. patent application Ser. No. 11/737,495 filed 19 Apr. 2007, now U.S. Pat. No. 7,520,772, which in turn is a continuation in part of U.S. patent application Ser. No. 11/420,646 filed 26 May 2006, now U.S. Pat. No. 7,226,308, all of the aforesaid patent applications and patents being owned by the assignee hereof. The disclosures of those patent applications are fully incorporated herein by reference.

### BACKGROUND OF THE INVENTION

There are many electrical connectors which are known from the published prior art or the marketplace. These connectors seek to connect together electrical conductors without soldering. Connectors exist for multistranded insulated wires or cables as well as coaxial cables.

Prior art connectors continue to have issues relative to their fit to particular conductor sizes, convenience and speed in making connections, physical firmness of connection and strain relief, and the introduction of unwanted resistance and capacitance by the connector in the conductor(s) or circuit lines so connected. Many of the prior art connectors require stripping the insulation off of a terminal portion of the multistranded wire, a step which consumes time and may result in the exposure of the bare wire to the environment. A need therefore persists for connectors which can make a quick yet secure electrical connection to any of various sizes of multistranded insulated electrical conductors.

### SUMMARY OF THE INVENTION

According to one aspect of the invention, an electrical connector is provided which includes a body with a bore having an axis, and a cap through which a multistranded electrical conductor is threaded. The bore has, near its bottom, an inwardly sloping surface. The cap terminates at its inner end with a plurality of gores or leaves which, when they cam against the inwardly sloping surface, will collapse axially inwardly and will grasp the external surface of the conductor which has been threaded through the cap and into the bore. Preferably, the connector body includes a center pin upon which an end of the electrical conductor has been impaled to effect electrical connection.

Preferably, the connector of the invention includes a means to affix the cap to the connector body, such that the gores of the cap remain cammed against the sloping surface of the bore and continue to hold the electrical conductor in place. One affixation means includes a ridge formed on one of the outer surface of the cap and the sidewall of the bore, and a groove formed in the other of the outer surface of the cap and the sidewall of the bore. Preferably there are at least two such grooves, in axial spaced-apart relation. It is also preferred that this groove and ridge be formed with a pair of surfaces, such that one of the surfaces has a substantially greater surface area than the other. The ridge will have a leading surface with an area greater than that of a trailing surface. The groove(s) each will have a first, axially inward surface, whose area is greater than that of a second, axially outward surface. In axial section these surface pairs can be straight, convexly curved or concavely curved. Creating the ridge and the groove(s) with such differential surface pairs creates a “sharktooth” effect in which the force necessary to extract the cap will be much greater than the force needed to insert it. Use of this affixation means avoids twisting of the connected stranded conductor.

An alternative affixation means includes threads on the cap external surface and the sidewall of the connector bore. Either method of affixation will create a high degree of strain relief and ensure a good physical and electrical connection. Other affixation means can be used, such as a push-in and turn or “bayonet” style fitting.

In one embodiment of the invention, the connector is provided in kit form to the user, with one connector body and a selection of different caps. Each provided cap has a different internal diameter, sized to receive a different range of conductor diameters.

Preferably, the gores of the cap have at least one ridge on their interior surfaces. These ridges are used to better grip the conductor. The connector preferably has a center pin which stands up from the bottom of the bore. This center pin can have one or more grooves in it, which also will aid in fastening the conductor in place once the cap has been clamped down on the conductor. In one embodiment, the ridges of the cap gores and the grooves in the pins are designed to be in registration with each other once the connection is completed, crimping strands of the conductor therebetween and enhancing both conduction and strain relief.

In another embodiment of the invention, the connector has a connector body with a bore, a cap, and a collar. The collar has a plurality of spaced-apart fingers or gores on its axially inward end. These fingers cam against the bottom sloped surface, as before. The collar is pushed into place by a cap that is inserted behind it and is affixed into place as by means of ridges and grooves.

The present invention has application to connectors which connect to single insulated conductors as well as multiple insulated conductors. Multiple bores in a connector body can be arranged in parallel to each other, each bore receiving a respective insulated conductor for connection. The connector body can have all of the bores on one side of its body, or alternatively can have one or more conductor-receiving bores on opposed sides of its body. In many multiple-conductor embodiments, individual caps are provided for respective conductors and these are received into respective bores. In other multiple-conductor embodiments, at least one multiple-conductor cap is provided which has a plurality of cavities therethrough, each of which accepts a respective conductor. The multiple-conductor cap can have parallel shafts surrounding and defining respective ones of the cavities, and these shafts are received in respective bores in the connector body. A sealing elastomeric o-ring can be provided to seal each shaft to the connector body, or alternatively one o-ring can be provided which surrounds all of the cap shafts and seals between an enlargement of the multiple conductor cap and a face of the connector body.

The bores of connectors according to the invention can each have more than two grooves, and the caps which fit into them can have two or more ridges. An array of multiple bores in such a connector body does not have to be two-dimensional but can instead be three-dimensional.

As alluded to above, the grooves and ridges can be reversed, such that the ridges project from a generally cylindrical surface of a connector body and the grooves are formed in a sidewall of a cap cavity. In such an embodiment, the body can have one or more such ridges and the cap should have two or more grooves which fit to them. This reversed embodiment has particular application in connecting to insulated coaxial conductors, in which the connector body further has a plurality of elongate piercing fingers designed to pierce through the external layer of insulation into a conductive sheath of the coaxial conductor. In one coax embodiment, the connector body has a central bore for receiving a stripped central conductor of the coaxial conductor. In another coax embodiment, the connector body has, axially outwardly extending from a face thereof, a hollow prong adapted to pierce the insulation surrounding the central conductor and to electrically connect to that central conductor. A sloping surface inside of the cap cavity cams the fingers into engagement with the conductor one the cap is compressed onto the body.

In one embodiment, a connector for a coaxial conductor further has an elastomeric gasket adapted to closely fit to the external insulation of the coaxial conductor. When the cap is compressed to be snap-fit to the second, axially inward ridge on the connector body, the gasket is compressed between the shoulders of the piercing fingers and an axially outward end wall of the cap, sealing the cap to the external surface of the conductor.

### BRIEF DESCRIPTION OF THE DRAWINGS

Further aspects of the invention and their advantages can be discerned in the following detailed description, in which like characters denote like parts and in which:

FIG. 1A is an exploded axial sectional view of a connector body and cap according to a first embodiment of the invention adapted to terminate a stripped coaxial cable;

FIG. 1B is a detail of the piercing fingers of the connector seen in FIG. 1A and taken substantially along line 1B-1B of FIG. 1A;

FIG. 2A is an exploded axial sectional view of a connector body and cap according to a second embodiment of the invention adapted to terminate an unstripped coaxial cable;

FIG. 2B is a detail of the piercing fingers of the connector seen in FIG. 2A and taken substantially along line 2B-2B of FIG. 2A;

FIGS. 3A and 3B are axial sectional views of a coaxial connector body and cap, respectively showing first and second stages in terminating a coaxial cable;

FIG. 4A is an axial sectional view of a third embodiment of the invention showing a first stage of assembly;

FIG. 4B is a side view of a connector body of the embodiment shown in FIG. 4A;

FIG. 4C is a side view of the connector body and cap shown in FIG. 4A, showing a final state of assembly of the connector and cap to a nonstripped insulated conductor;

FIGS. 5A and 5B illustrated initial and final assembly stages of an in-line connector embodiment otherwise similar to the embodiment shown in FIGS. 4A-4C;

FIGS. 6A and 6B show initial and final assembly stages of a multiple-conductor embodiment adapted from the embodiment shown in FIGS. 4A-4C, with a unitary connector body and separate caps;

FIGS. 7A and 7B show initial and final assembly stages of a multiple-conductor embodiment in which both the connector body and cap are unitary;

FIGS. 8A-8C are axial sectional views of a family of caps according to a further embodiment of the invention, in which a cap is selected according to the diameter of the insulated conductor to which connection is to be made;

FIG. 8D is a side elevational view of one of the caps shown in FIGS. 8A-C;

FIG. 9 is an axial sectional view of a female connector body designed for use with the caps of FIGS. 8A-8D;

FIGS. 10A and 10B are axial sectional illustrations of initial and final assembly stages of the caps shown in FIGS. 8A-D, in combination with a two-groove connector body;

FIG. 11A illustrates a first stage of assembly of a further embodiment employing a collar, cap and female connector body to make a connection to an unstripped insulated conductor;

FIGS. 11B-C respectively are end and side views of a collar for use in the embodiment shown in FIG. 11A;

FIG. 11D is a side elevational view of a cap for use in the embodiment shown in FIG. 11A;

FIG. 12 is an axial sectional view of a final assembly stage of the embodiment shown in FIG. 11A;

FIGS. 13A and 13B show initial and final assembly stages of an in-line connector adapted from the embodiment shown in FIGS. 11A-D and 12;

FIGS. 14A and 14B show initial and final assembly stages of a further embodiment of the invention;

FIGS. 15A and 15B show initial and final assembly stages of an in-line connector embodiment developed from the embodiment shown in FIGS. 14A and 14B;

FIGS. 16A-16B are axial sectional views of two sizes of a notched cap according to a further embodiment of the invention, meant to receive differently sized conductors;

FIG. 16C is an elevational view of one of the notched caps shown in FIGS. 16A and 16B;

FIG. 17 is an axial sectional view of a connector body including a grooved center pin, particularly for use with the caps illustrated in FIGS. 16A-C;

FIG. 17A is a detail of FIG. 17;

FIG. 18A is an axial sectional view showing the cooperation of the cap of FIG. 16C with the connector body of FIG. 17, in a first stage of connection;

FIG. 18B is an axial sectional view of the cap and connector body shown in FIG. 18A, in a second stage which completes the connection to a conductor;

FIG. 19 is a part-sectional, part-elevational exploded view of a multiple connector provided to splice two pairs of conductors;

FIG. 20 is a part-elevational, part axial sectional view a multiple connector including a two-conductor splicing connector body which has five grooves in each bore;

FIG. 21 is a part-elevational, part axial sectional view of a multiple connector including a two-conductor splicing connector body having five grooves in each bore, and two caps each having five ridges;

FIG. 22 is a part-elevational, part axial sectional view of a multiple connector including four bores each having four grooves in each bore, and two multiple-conductor caps for insertion into respective pairs of the bores;

FIG. 22A is a sectional view of the multiple cap shown in FIG. 22;

FIG. 23 is a part-elevational, part axial sectional view of a connector having a connector body with convexly curved camming surface and internal threads in the bore, and a cap with external threads; and

FIG. 24 is a part-elevational, part axial sectional view of an in-line splice connector similar in its details to the connector shown in FIG. 23.

### DETAILED DESCRIPTION

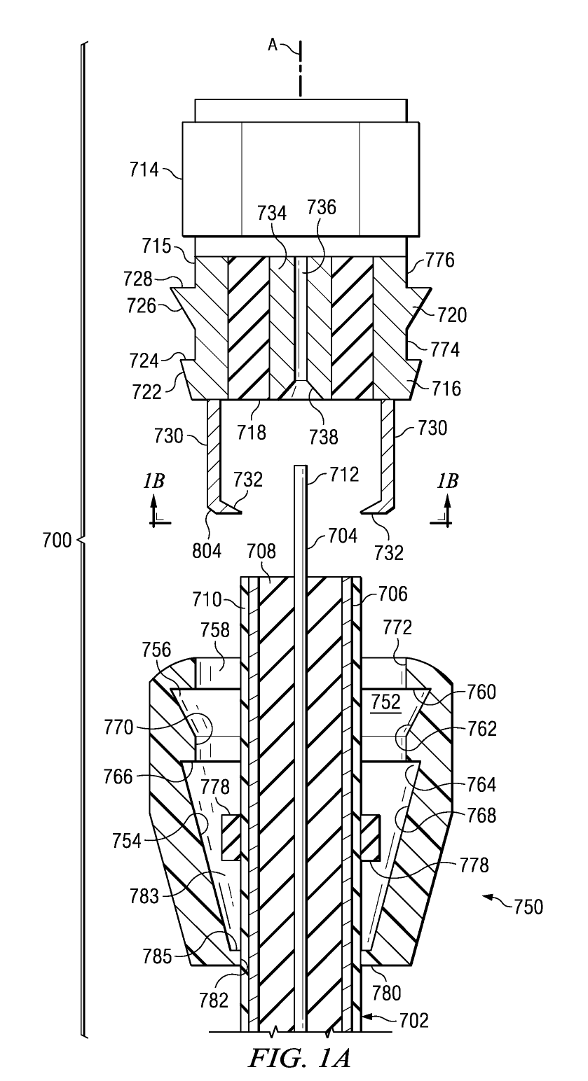

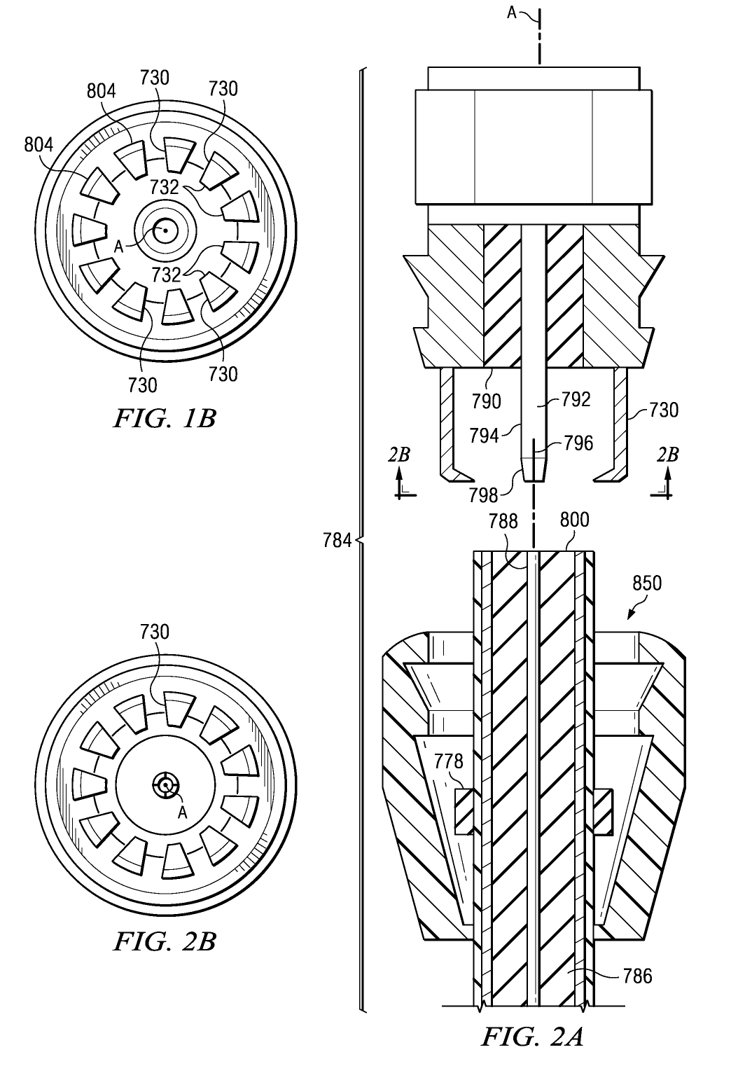

FIG. 1A is an exploded view of a connector 700 suitable for terminating a coaxial cable 702. The coaxial cable 702 has a solid center conductor 704 and a conductive sheath 706, both of which require connection to further electronic components. Sheath 706 and central conductor 704 are separated by coaxial insulation 708 and the entirety of cable 702 is protected by a layer of external insulation 710. This embodiment is provided for coaxial conductor ends from which insulation 710, sheath 706 and insulation 708 have been stripped, leaving a bare length 712 of the central conductor 704.

A coaxial cable connector body 714 has a generally cylindrical exterior surface 715 (as “cylindrical” is understood in its broad mathematical definition, meaning having a substantially uniform cross section throughout its axial length; e.g. body 714 could be polygonal, oval or otherwise noncircular in axial cross-section) that is formed in whole or in part of a conductive material. In the illustrated embodiment, the body 714 has a first ridge 716 proximate a front face 718 of the body. The ridge 716 is formed to be at an angle to the axis A and is preferably orthogonal thereto. Spaced from this first ridge 716 to be more remote from the front face 718 is a second ridge 720. Second ridge 720 is formed at an angle to the axis and preferably is orthogonal thereto. Both the first and second ridges are preferred to be circumferential relative to the axis A of the connector 700, but they could be discontinuous. A radius of ridge 716 at its largest point is greater than a radius of the generally cylindrical surface 715 of the body 714. Preferably the greatest radius of ridge 720 is greater than the greatest radius of ridge 716.

The ridge 716 is formed by a leading surface 722 which extends axially rearwardly and radially outwardly from the general cylindrical surface 715, and a trailing surface 724 joined to an outer end of the leading surface 722 and extending radially inwardly back to the general exterior surface 715. The leading surface 722 and the trailing surface can each take various shapes (e.g., they can be straight, convexly curved or concavely curved), but the leading surface 722 should always have an area which is substantially greater than the area of trailing surface 724. Surface pairs 722, 724 which satisfy this criterion will exhibit more resistance to cap/conductor pullout than they will to cap/conductor assembly to the body 714. In the illustrated embodiment, surface 722 begins at front connector body face 718 and is frustoconical; in other embodiments surface pairs 722, 724 could be displaced rearwardly on the general exterior surface 715. The trailing surface 724 in the illustrated embodiment is annular and conforms to a plane which is orthogonal to axis A.

In the illustrated embodiment the second ridge 720 is likewise formed by a leading surface 726 and trailing surface 728. The leading surface starts at the radius of the general exterior surface 715 and proceeds radially outwardly and axially rearwardly until its junction with trailing surface 728, at which point its radius from axis A is greater than the radius of the generally exterior surface 715. Trailing surface 728 extends radially inwardly until it meets the general outer surface 715 of the connector body 714. In the illustrated embodiment, surface 726 is frustoconical and surface 728 is annular and orthogonal to axis A, but they could be chosen to be otherwise. For example, surfaces 726 and/or 728 could be convexly or concavely curved. But the area of leading surface 726 should always be greater than that of trailing surface 728.

Conductively connected to the connector body 714 are a plurality of conductive piercing fingers 730, two of which are shown in FIG. 1A. FIG. 1B is an end view of fingers 730, illustrating their axially circumferential distribution. Each finger 730 has a shoulder 804 from which extends in a radially inward direction a point or edge 732 that is long enough and sharp enough to pierce through the insulation 710 and contact conductive sheath 706. Points or edges 732 should not be so long that they would penetrate to central conductor 712. In an initial, uncompressed position, the fingers 730 do not engage the external insulation 710 of coaxial conductor 702 but permit the insertion of coaxial conductor 702 to the face 718 of the body 714.

In this embodiment, the connector body 714 has a conductive central portion 734 with a bore 736. Bore 736 may be beveled at its entrance 738 so that stripped central conductor 712 may be more easily registered with and inserted into bore 736.

The other major component of coax connector 700 is a cap indicated generally at 750 which has an axial cavity 752 through which the coax conductor 702 is threaded. The cap 750 may be formed of either conductive or insulative material. An internal sidewall 754 of the cap 750 has a first groove 756 formed to be near an axially inward opening 758 of the cap 750. The groove 756 is formed at an angle to axis A (preferably at right angles to it) and has a radius at its deepest point from axis A which is greater than the radius of an adjacent portion of the inner cavity sidewall 754. The first groove 756 is made up of a first, leading surface 760 and a second, trailing surface 762. The area of leading surface 760 should be chosen to be substantially less than that of the trailing surface 762. In the illustrated embodiment, the leading surface 760 is formed to be an annulus at right angles to axis A, and the trailing surface 762 is formed to be frustoconical. Surfaces 760, 762 may be chosen to be straight in axial cross section or profile (as shown) or could be convexly or concavely curved, or take other shapes.

The internal sidewall 754 has a further, second groove 764 which is formed to be axially outward (here, downward) from the first groove 756. The second groove 764 is also formed of a respective leading surface 766 and a trailing surface 768, where the area of the leading surface 766 is substantially less than that of the trailing surface 768. Groove 764 is formed at an angle to axis A (preferably at right angles to it) and has a radius at its deepest point from axis A which is greater than the radius of an adjacent portion of the inner cavity sidewall 754. The leading surface 766 is here chosen to be an annulus at right angles to axis A, while the trailing surface 768 is chosen to be frustoconical. As in other surface pairs discussed herein, surface pair 766, 768 can be chosen to be other than straight in axial profile, such as convexly or concavely curved.

In this illustrated embodiment, the grooves 756 and 764 are spaced apart by a surface 770 which is parallel to axis A. Surface 770 can be cylindrical or prismatic, for example. First groove 756 is spaced from opening 758 by a surface 772 which is parallel to axis A and whose length in an axial direction is about the same as the axial length of surface 770. These surfaces 770, 772 match up with an axially parallel exterior surface or land 774 on connector body 714, spacing apart ridges 716 and 720, and an axially parallel exterior surface or land 776 on connector body 714, axially forward (here, upward) of ridge 720.

The connector 700 also includes an “o-ring” or gasket 778 made out of an elastomer and which preferably has a rectangular (rather than circular) cross-section. The o-ring or gasket 778 is sized to closely fit on the exterior surface of the insulated conductor 702. A preferred shape of gasket 7788 has a rectangular cross-section, as shown.

An outer axial end wall 780 of the cap 750 has an opening 782 which closely receives the conductor 702. A section 783 of the inner sidewall 754, here shown to be continuous with trailing surface 768, tapers from the groove 764 axially outwardly such that its radius gradually decreases. Preferably, at an outer axial end 785 of the surface 783, the radius of surface 783 is chosen to be smaller than an outer radius of the gasket 778.

FIGS. 2A-B show an alternative embodiment of a coaxial connector 784 according to the invention meant to connect to an insulated coaxial conductor 786 which has an unstripped central conductor 788. A connector body 790 of the connector 784 has a conductive coaxial tube or hollow prong 792 whose sidewall 794 may be slit with a slit 796, as shown. A sharpened end 798 of the prong 792 is adapted to penetrate the interconductor insulation 800 of the conductor 786, so as to surround and contact a length of the central conductor 788. Outside of the structure provided to connect to the center conductor 788, the cap 784 is identical to cap 700 illustrated in FIGS. 2A-B.

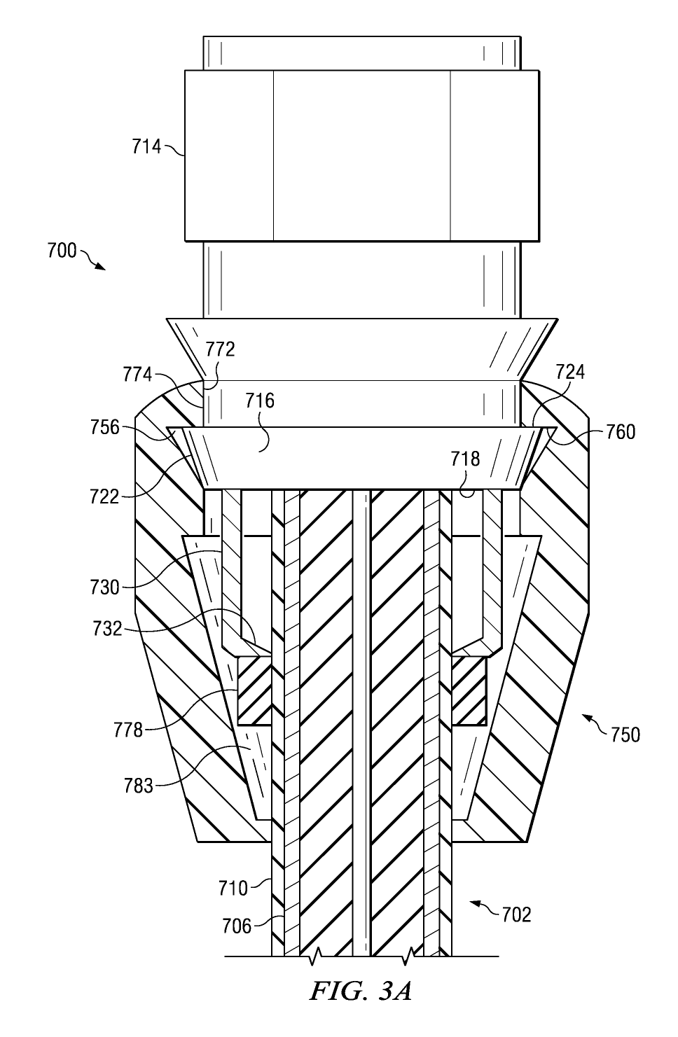

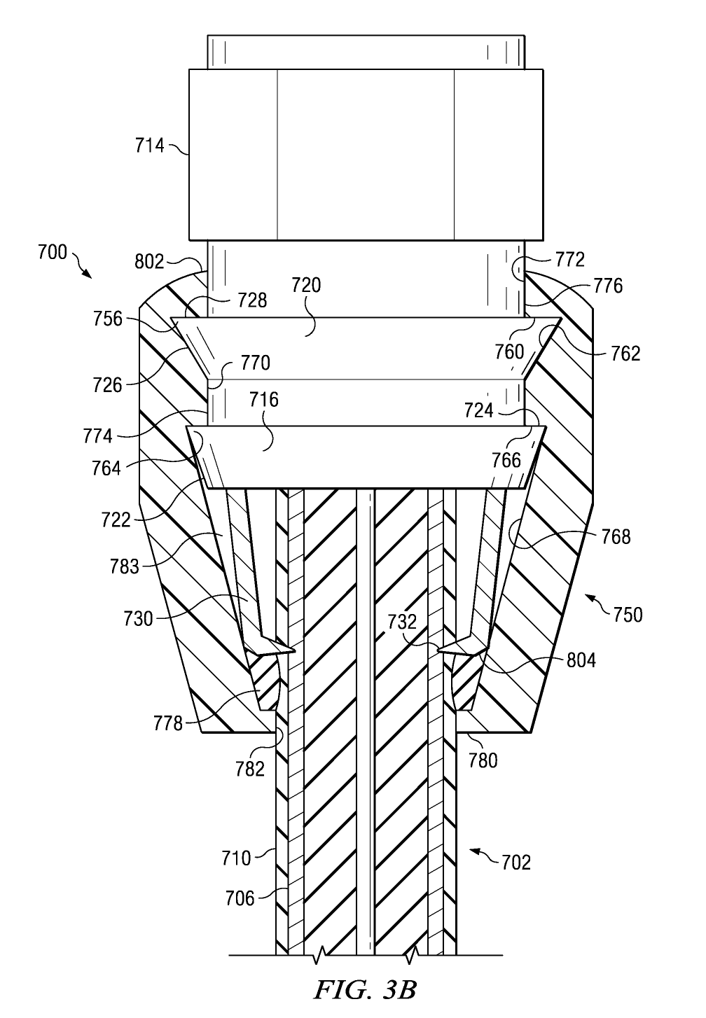

A first stage of termination of conductor 702 by connector 700 is shown in FIG. 3A. At this stage, the conductor 702 has been inserted until it abuts inner face 718. In the instance that a conductor 702 has been provided which has a stripped central conductor 712, the stripped portion is received within the interior of the connector body 714. In the instance that an unstripped coaxial conductor 786 is provided, the connector 784 of FIGS. 2A-2B is used, wherein the hollow prong 792 (not shown in this FIGURE) makes connection with the center conductor.

The beginning surface 772 of the cap 750 has been snapped over the first ridge 716, so that axially parallel surface 772 rests on connector body surface 774 and first groove 756 is in registry with the first ridge 716. The connector 700 may be provided to the user this way, in a preassembled condition. In this posture the prongs or fingers 730 have yet to pierce through the outer insulation 710 of the conductor 702.

FIG. 3B shows a second, final stage of connection. The cap 750 has been pushed or compressed, either manually or with the aid of a plier-like tool (not shown), axially inwardly (upward in this FIGURE) until the axial inner end 802 of the cap 750 has slid over surface 762 of the connector body 714 until end 802 “snaps” past right annular trailing surface 760 to rest on land or axially parallel surface 772. While this is happening, surface 774 of the cap 750 pushes up leading surface 722 and snaps over connector body trailing surface 724, to fit onto parallel surface 770 of the connector body 714. In this condition, and in the illustrated embodiment, two ridges 716, 720 mate with respective grooves 764, 756.

Also during this compression step, camming surface 783 of the cap 750 pushes tips 732 of piercing fingers 730 through the outer insulation 710 of conductor 702 and into the conductive sheath 706. Finally, the elastomeric “o” ring or gasket 778 is compressed between an axially inward wall of cap end 780 and an axially outer end or shoulder 804 of each finger 730, sealing the cap bore end 782 to the external surface of insulated conductor 710.

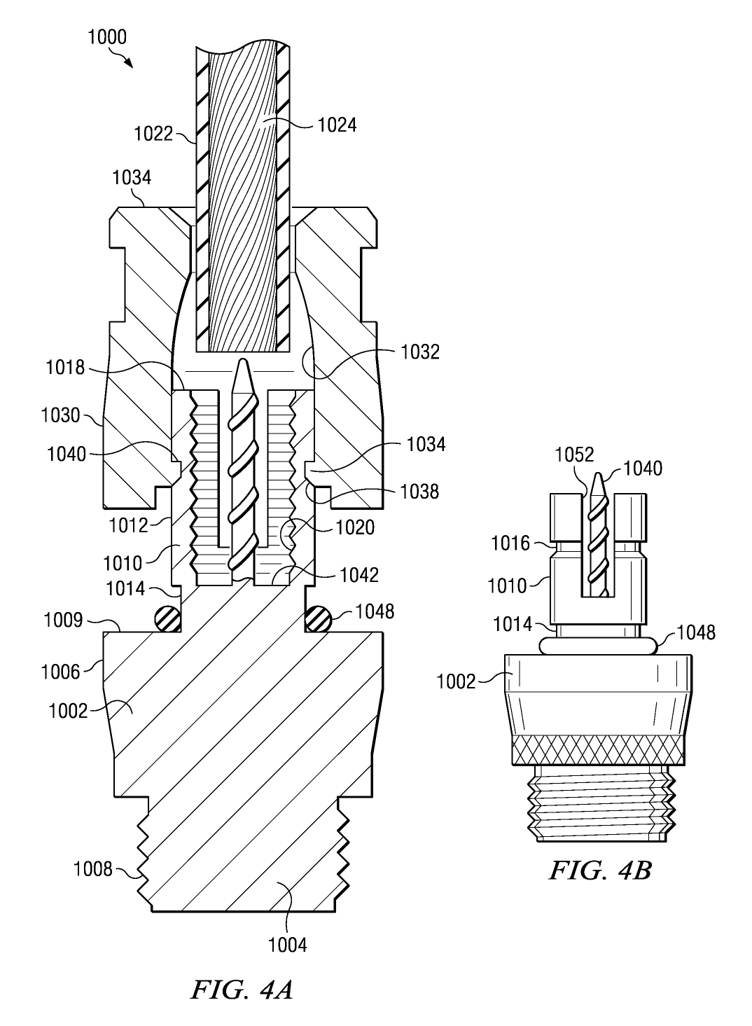

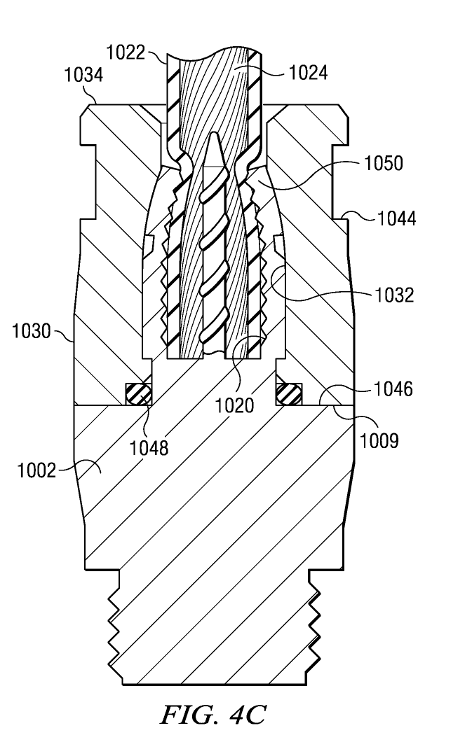

In the embodiment shown in FIGS. 4A-4C, a single-end connector indicated generally at 1000 has a preferably conductive female body 1002. The external radial surface of a rear end 1004 of the body 1002 can be screw-threaded to accept any of a plurality of different equipment connectors, such as a spade, a banana plug or a pin (not shown). An external surface 1006 forward of the screw threads 1008 can take any convenient shape, such as a hex shape or a shape which is knurled. The body 1002 has a substantial step or surface 1009 which, in the illustrated embodiment, is orthogonal to the longitudinal axis of the connector 1000.

At its forward axial end, the connector body 1002 has a substantially cylindrical tube 1010. An external surface 1012 of the tube 1010 is cylindrical in cross section (where “cylindrical” takes its broad mathematical definition). The tube 1010 has a pair of grooves: an axially inward groove 1014 which is close to or adjoins the step 1009, and an axially outward groove 1016 which is spaced rearwardly from a front end 1018 of the tube 1010. The grooves 1014 and 1016 are spaced a considerable distance apart from each other on tube 1010, and define initial and final assembly positions of a cap which indexes to them, as will be described below.

An internal surface 1020 of the tube 1010 is roughened or threaded in order to grip the external insulation 1022 of an insulated conductor 1024 to be connected by connector 1000. An internal diameter of the tube 1010 is chosen to be at least a little larger than an external diameter of the conductor 1024.

A cap 1030 has an internal bore or cavity 1032 with a ridge or constriction 1034 at its inner axial end 1036. The ridge 1034 may have a leading beveled or sloped surface 1038 that has a surface area that is larger than a trailing surface 1040, which in the illustrated embodiment is annular and at right angles to the longitudinal axis A of the connector 1000. From ridge 1034, and proceeding forward along axis A, the surface of bore or cavity 1032 quickly increases in diameter until it is larger than an external diameter of the tube 1010. The surface of cavity 1032 then begins to decrease in diameter until it intentionally is less than the external diameter of tube 1010 by the time one reaches an outward axial end 1034 of the cap 1030.

In the operation of this embodiment, the connector 1000 may be provided to the user in the condition in which it is shown in FIG. 4A. The user then inserts a conductor 1024 through end 1034 of the cap 1030 and into tube 1010 of the female connector body 1002. In the illustrated embodiment the user twists the conductor onto a helically threaded center pin 1040 which is conductively joined to body 1002; in another embodiment the helically threaded center pin 1040 may be replaced with a nonthreaded center pin so as to permit an impalement of the conductor 1024 onto such a pin without twisting. In either event the conductor 1024 is advanced down within tube 1010 until a base 1042 of the tube 1010 is reached.

FIG. 4C shows a final stage of assembly. The cap 1030 has been pushed down axis A, either manually or with the aid of a tool which can fit onto land 1044 or end 1034, until a front end 1046 of the cap 1030 mates with surface 1009 of the body 1002. It is preferred that the surface 1046 of cap 1030 mate or be congruent with the surface 1009 of the connector body 1002. When this happens, the cap ridge 1034 will register with axially inward groove 1014, locking cap 1030 in place relative to body 1002. The cap ridge also preferably compresses an O ring 1048 disposed in groove 1014 to seal the cap 1030 to the body 1002.

As cap 1030 is slid home on body or base 1002, the surface of cavity 1032 will begin to compress the sidewall of tube 1010 inwardly until its internal surface 1020 begins to grip and compress the insulation 1022 of conductor 1024. This compression is maximized at cavity constriction 1050 near end 1034. The compression is made possible or enhanced by longitudinal slits 1052 (FIG. 4B) in tube 1010, which more easily permit the collapse of the sidewall of malleable tube 1010 onto the conductor 1024. The result is a firm connection between the conductor 1024 and the connector 1000.

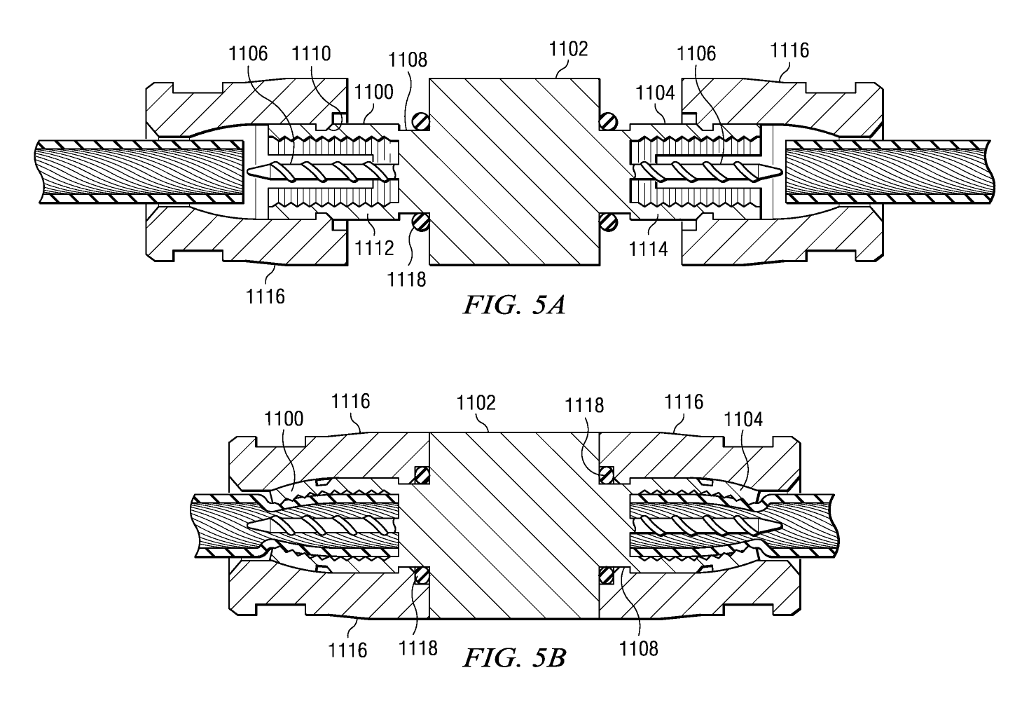

FIGS. 5A and 5B illustrate an in-line splice embodiment of this connector. A first slitted tube 1100 extends in one axial direction from a body 1102 while a second slitted tube 1104 extends in an opposite axial direction. Each slitted tube 1100, 1104 has a center pin 1106, axially inward and outward grooves 1108, 1110 on its external surface 1112, and an inner surface 1114 which may be roughened, knurled or threaded. Each such tube 1100, 1104 is provided with a separate cap 1116 which in form and operation is similar to cap 1030 of FIGS. 4A-4B. For each axially inward groove 1108, a compressible O-ring 1118 may be provided which compresses upon the advancement of cap 1116 axially inwardly on tube 1100 or 1104.

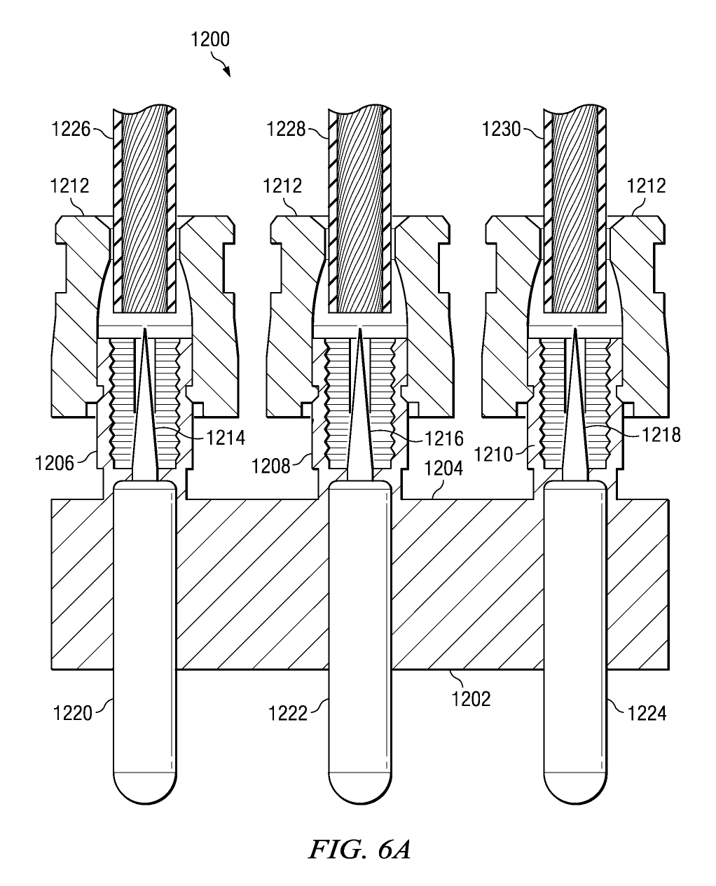

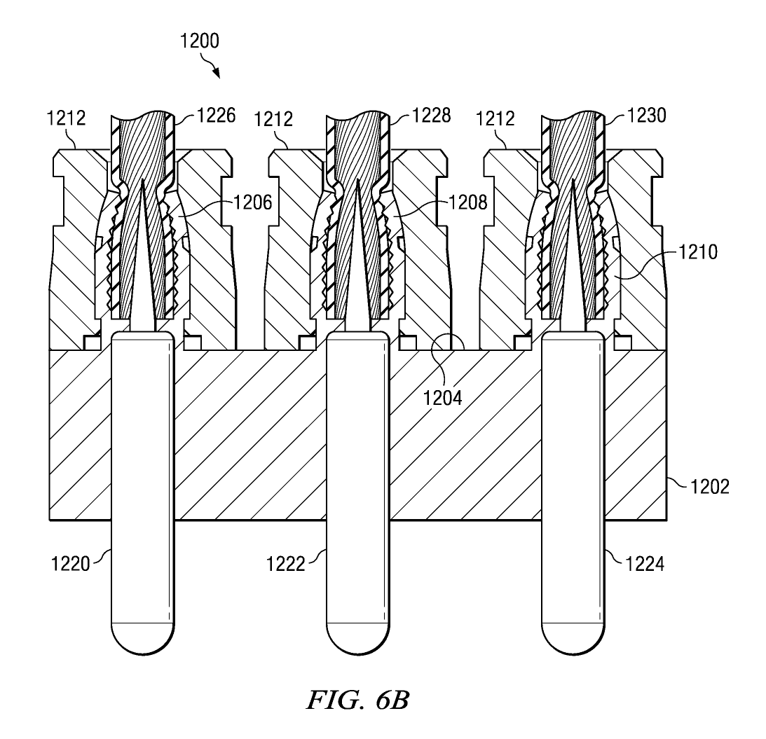

FIGS. 6A and 6B show a similar embodiment 1200 in which a unitary connector body 1202 has a flat base surface or land 1204 from which a plurality of tubes 1206, 1208, 1210 project in parallel in one direction. Each slitted tube 1206, 1208, 1210 is similar in its construction and function to tube 1010 of FIGS. 4A-4C. For each such tube 1206-1210, there is provided a respective cap 1212 similar in construction and function to cap 1030 of FIGS. 4A and 4B. The body 1202 can be formed of an insulator and has inserted or in-molded therein conductive elements 1214, 1216, 1218, respectively centered on the axes of tubes 1206-1210 and terminating inside tubes 1206-1210 with respective conical connection elements 1220, 1222, 1224. The conical elements could be replaced with other sorts of center pins. In this embodiment, in many instances twisting each insulated conductor 1226-1230 onto a center pin is to be avoided, as where the conductors 1226-1230 are parallel conductors of a wiring harness. FIG. 6A shows this parallel connector in an initial assembly position, in which independent caps 1212 have not been advanced onto base 1204, and FIG. 6B shows the connector 1200 in a final assembly position.

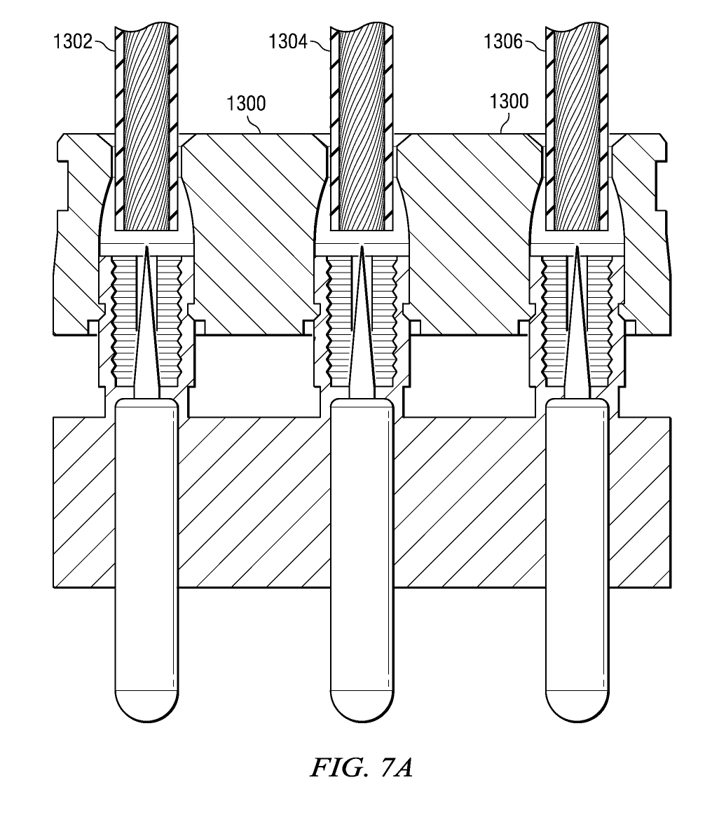

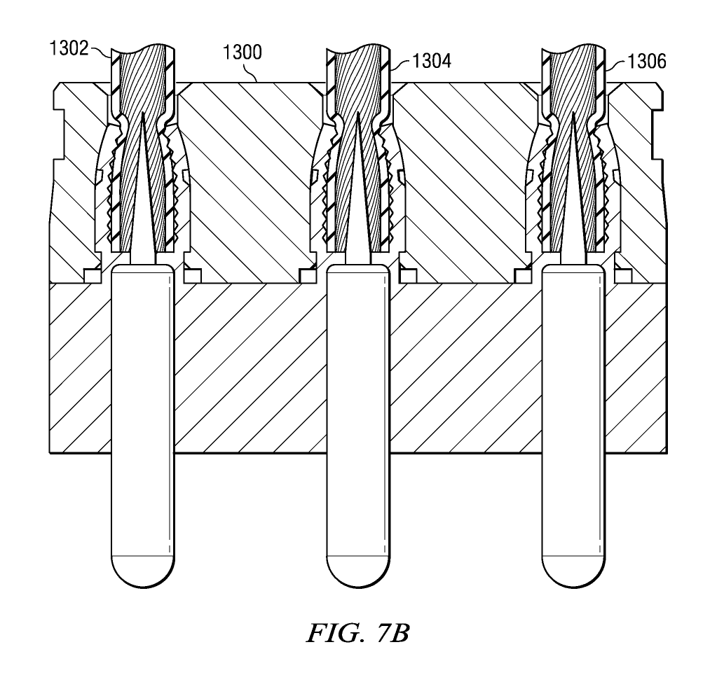

FIGS. 7A and 7B show an embodiment similar to the one shown in FIGS. 6A and 6B, but instead of independent caps 1212 there is provided a single multiconductor cap 1300, which completes the connection to multiple conductors 1302-1306 all at the same time.

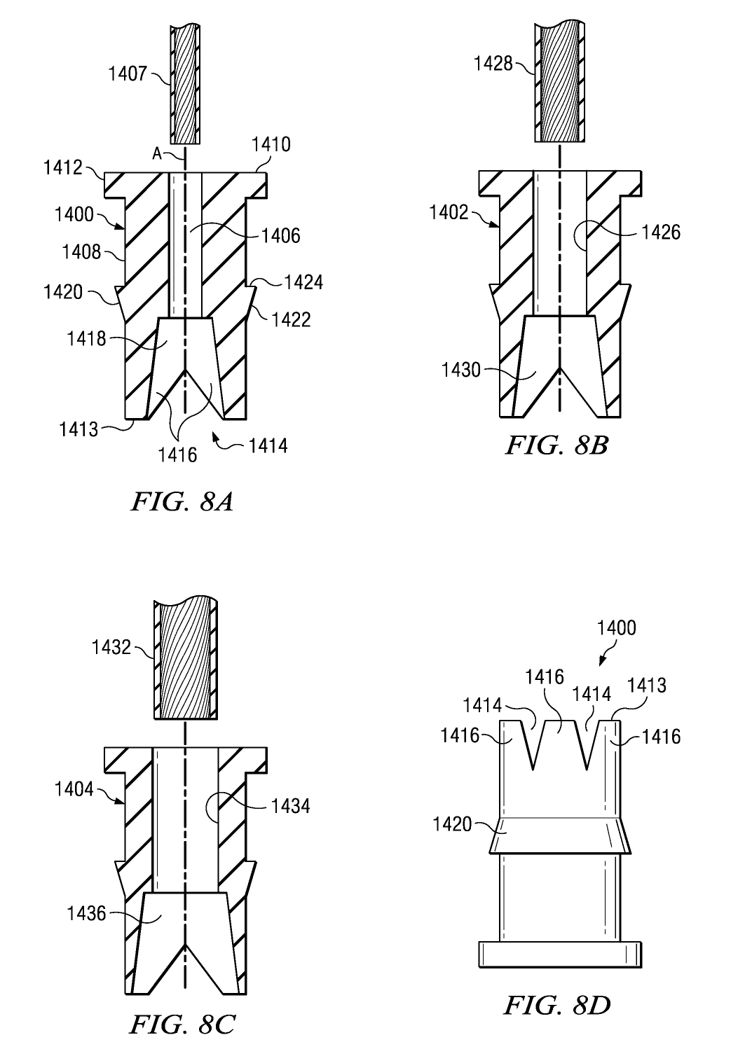

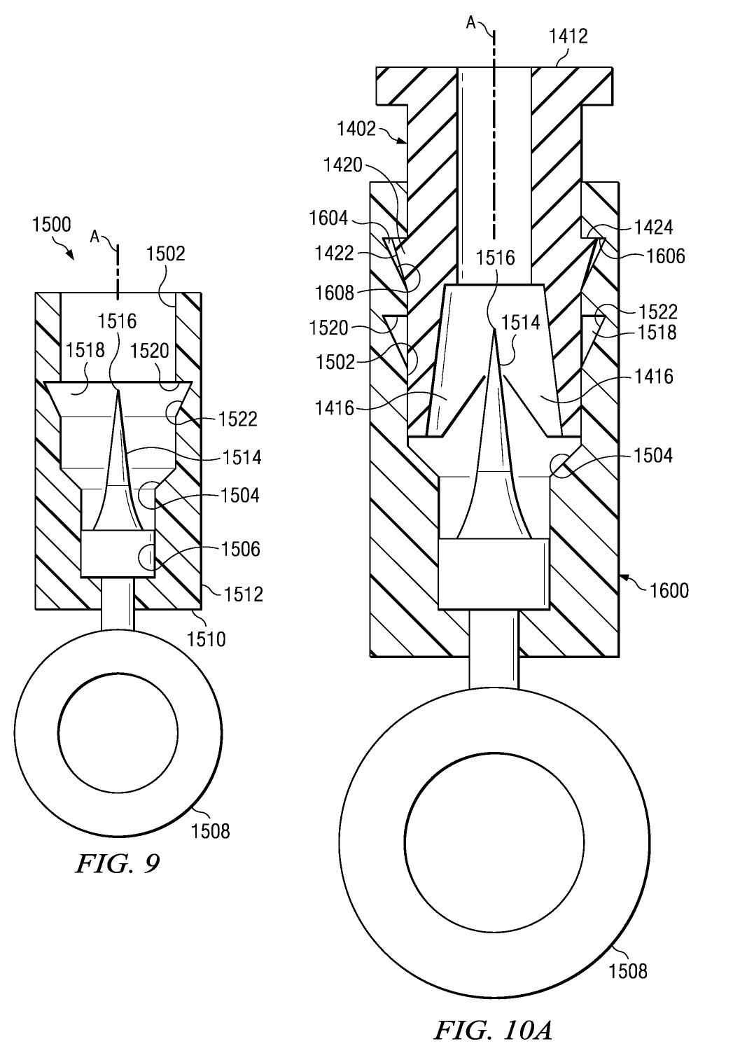

A different embodiment of the invention is depicted in FIGS. 8A-10B. FIG. 9 is an axial sectional view of a single-snap female connector body 1500 having a substantially cylindrical bore 1502. The bore 1502 terminates at its inner axial end with a beveled or sloped surface 1504. The surface 1504 can be straight in this section, as shown, or can be curved. An axial inner end of the surface 1504 is joined to a bore 1506 of smaller diameter. A conductive element 1508 extends through a back wall 1510 of the connector body 1512. Body 1512 can for example be injection-molded of plastic. The conductive element in the illustrated embodiment is an annular connector element for a screw connection or the like, but could as easily be a pin, banana plug, spade or other common connector shape. In embodiments alternative to the ones illustrated, the conductive element 1508 and its analogs can have one or more radial processes meant to be in-molded into the connector body 1512.

While in the illustrated embodiment the body 1500 and most of its analogs are shown to be made of an insulative material, for many applications it can be fabricated from metal. The body 1500 preferably should be formed of a material that is somewhat elastic, so that it will stretch slightly and snap back during one or more stages of insertion of the cap and conductor into the bore 1502. But body 1500 should not be so elastic that the connection will easily fail because of the conductor or cap being pulled back out of the body.

The connector element 1508 extends axially outwardly into bore 1502 and terminates in a center pin 1514 which, in the illustrated embodiment, has a concavely curved axial section and ends in a sharp tip 1516. Tip 1516 is designed to impale an end of an insulated stranded conductor.

The bore 1502 has along its length a groove 1518 which, like other embodiments disclosed herein, is formed of a differential surface pair such that a leading surface 1520 thereof has a smaller surface area than that of a trailing surface 1522. In the illustrated embodiment, surface 1520 is at right angles to an axis A of body 1500 while surface 1522 is frustoconical. While surfaces 1520, 1522 are shown to be straight in axial cross section, they could be convexly or concavely curved. More particularly the surface 1520 starts at the general cylindrical surface of bore 1502 and extends radially outwardly until it intersects with the frustoconical surface 1522. Frustoconical surface 1522 proceeds from its junction with annular or step surface 1520, radially inwardly (toward axis A) and axially inwardly (toward the bottom of the bore) until the general cylindrical surface of bore 1502 is again reached.

Any one of a plurality of caps 1400, 1402, 1404 (see FIGS. 8A-8C) can be inserted into the bore 1502 of connector 1500. Taking cap 1400 as an example, there is provided an axial bore 1406 sized to closely receive a conductor 1407 of a specific size or range of sizes. An outer surface 1408 of cap 1400 is substantially cylindrical in form (using the broad mathematical definition of cylinder; both curved and polygonal axial cross sections are contemplated). An axially outer end 1410 of the cap 1400 can be provided with an enlargement 1412 so as to receive a jaw of a compression tool (not shown).

An inner axial end 1413 of the cap 1400 has a plurality of V-shaped slits 1414 formed therein (see also FIG. 8D) such that a large portion of the cross sectional area of the cap 1400 has been removed at the axial location of end 1413. The remaining gores 1416, which preferably are four in number, are thus capable of being collapsed inwardly toward axis A upon the application of sufficient force.

The inner bore 1406 terminates at an axially inner end thereof in an enlarged cavity 1418. The cavity 1418 creates an interior volume to accommodate the spread of the strands of conductor once the conductor 1407 has been impaled on center pin 1514.

A ridge 1420, which can be axially circumferential, is formed on the external cylindrical surface 1408 to radially outwardly extend therefrom. The ridge 1420 is preferably formed as a differential surface pair, where a leading edge 1422 has more surface area than a trailing edge 1424. The shape of ridge 1420 preferably conforms to the shape of groove 1518 of female connector body 1500 and also conforms to groove 1518 in axial position. The leading surface 1422 of ridge 1420 can be frustoconical, as shown, or could be a surface which is curved in axial section; the trailing surface 1424 in the illustrated embodiment is annular and is at right angles to axis A of the cap 1400, but could take another form.

Caps 1402 and 1404 are identical to cap 1400 except for two variations. The cap 1402 (FIG. 8B) has an internal bore 1426 which is larger than bore 1406, as it is designed to closely receive a conductor 1428 that has a larger diameter. An ending cavity 1430 is also larger than end cavity 1418, as more strands of conductor will have to be accommodated once the conductor 1428 is impaled on center pin 1514. Cavities 1418 and 1430 take a reverse frustoconical shape in the instance that center pin 1514 has an increasing cross sectional area as one proceeds axially inwardly. The cavities 1418 and 1430 would be formed as straight cylinders if center pin 1514 took a straight cylindrical shape.

The cap 1404 (FIG. 8C) is designed to receive a conductor 1432 of even larger diameter. Hence, it has a larger bore 1434 that is slightly larger in diameter than conductor 1432, and a larger end cavity 1436 that can accommodate a larger volume of conductive strands.

Bore 1502 is furnished with a groove made from a differential surface pair 1520, 1522, and any of caps 1400-1404 are furnished with a ridge having a differential surface pair 1422, 1424. So specifying the groove 1518 and the ridge 1420 will make sure that the cap 1400-1404 will be easier to insert into the bore 1502 than it will be to pull out.

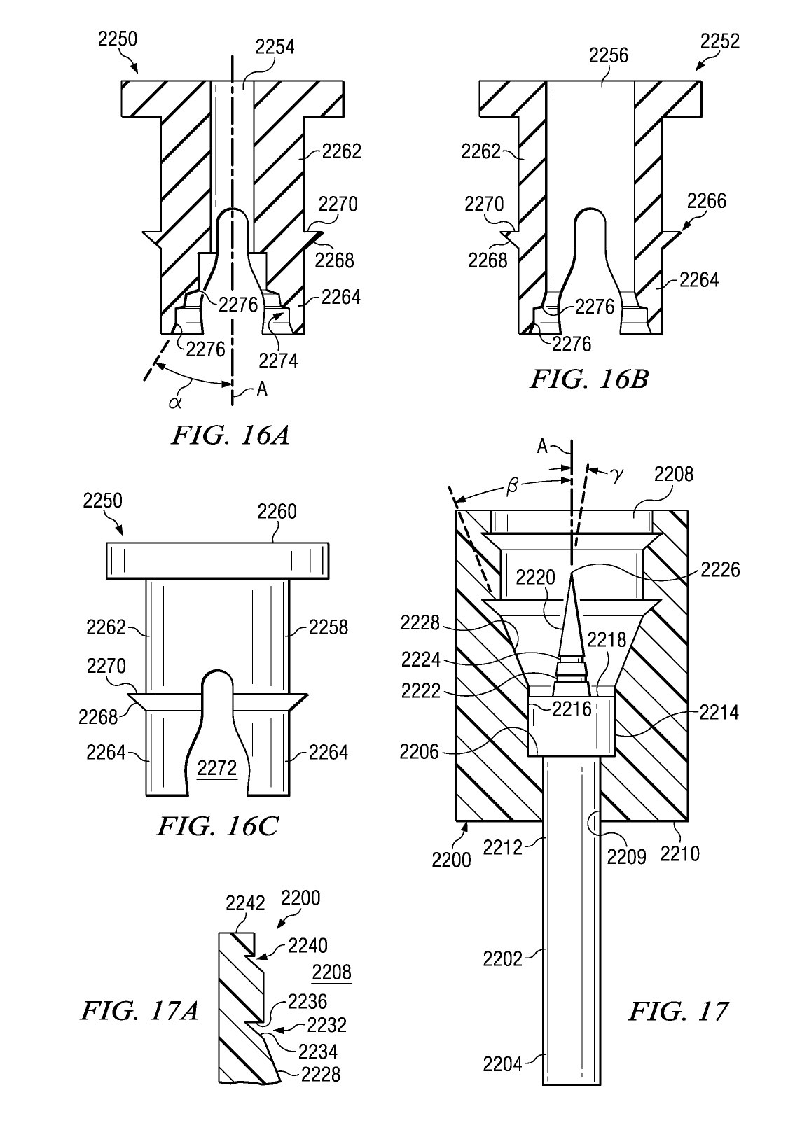

In this embodiment, groove 1502 and ridge 1402 are shown to be endless, but they could also be discontinuous. For embodiments including a discontinuous cap ridge, see e.g. FIGS. 16A-24.

The caps 1400-1404 in one embodiment could be furnished in a kit with one of the female connector bodies 1500 or 1600 (the latter of which is described below). In this embodiment, the user would, as a first step in using the connector, select one of the caps 1400-1404 for the size of conductor 1407, 1428, 1432 to be connected. This cap would then be threaded onto the conductor 1407, 1428, 1432 prior to the connection of the cap and conductor to the female connector body 1500 or 1600.

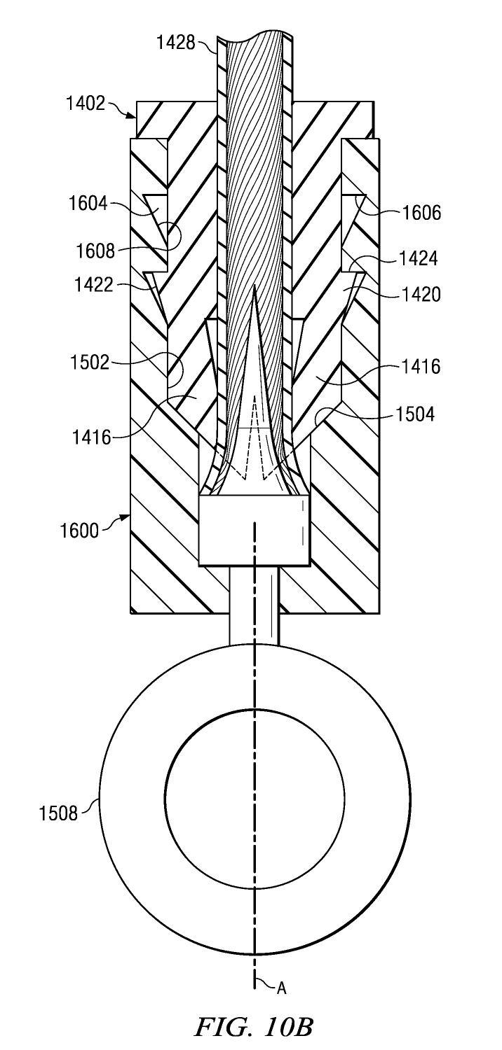

A double-snap connector body 1600 is shown in FIGS. 10A and 10B. Connector body 1600 is in general similar in dimension and constitution to connector body 1500, and hence like characters identify like parts. A bore 1602 can even be the same length as bore 1502 of the connector body 1500 (FIG. 9). The only difference is that the bore 1602 is provided with a second, axially outward groove 1604 which can be formed by a differential surface pair 1606, 1608, similar in form to surface pair 1520, 1522 of axially inward groove 1518.

In an embodiment alternative to providing multiple caps 1400-1404 (three are shown, but the number is exemplary only), a cap (such as cap 1402) can be pre-inserted into the two-snap female connector body 1600 prior to sale to the user. In this condition, the ridge 1420 would occupy the axially outward groove 1604.

In using the embodiment shown in FIGS. 10A-10B, the user takes the end of a multistranded conductor and passes it through the cap 1402, into bore 1502 and onto pin 1514, such the strands of the conductor (for cap 1402, this would be conductor 1428) are spread by the pin 1514. The cap 1402 is advanced, as by application of a tool to land 1412, axially inwardly into bore 1502. When this happens the gores 1416 of the cap 1402 encounter the beveled or sloped surface 1504 of the bore 1502, and begin to inwardly collapse toward the axis A of the connector. This tightly grips the conductor. After sufficient advance the ridge 1420 of the cap 1402 snaps into axially inward groove 1518, firmly completing the connection. The V-shaped slits 1414 made in the end 1413 of the cap permit the axial collapse of gores 1416.

FIG. 10A also illustrates that the angle of bevel of ridge surface 1422 doesn't have to be the same a the angle of bevel of groove surface 1608, and in many instances will be chosen to be less in order to make the insertion of the cap 1402 to the first position easier. The angle of bevel of a corresponding surface of groove 1518 can be chosen to be the same as that of surface 1608 but doesn't have to be.

Using two grooves as does the embodiment shown in FIG. 10A also provides the user with two distinct indexing positions for the cap 1402. The user will be able to feel the cap snap to either of these positions. When the cap snaps to the second groove 1518, the user will know that the cap has been inserted far enough that an adequate electrical and physical connection has been made.

In the embodiment shown in FIG. 9, the user selects one of caps 1400-1404 and threads it onto a respective one of the conductors 1407, 1428, 1432. The conductor is then impaled onto pin 1514. Thereafter, the cap 1400, 1402 or 1404 is advanced down bore 1502, as by means of a compression tool, until ridge 1420 registers with the groove 1518. By the time this happens, the gores 1416 will have encountered sloped surface 1504 and will have collapsed on the conductor, firmly affixing it in place.

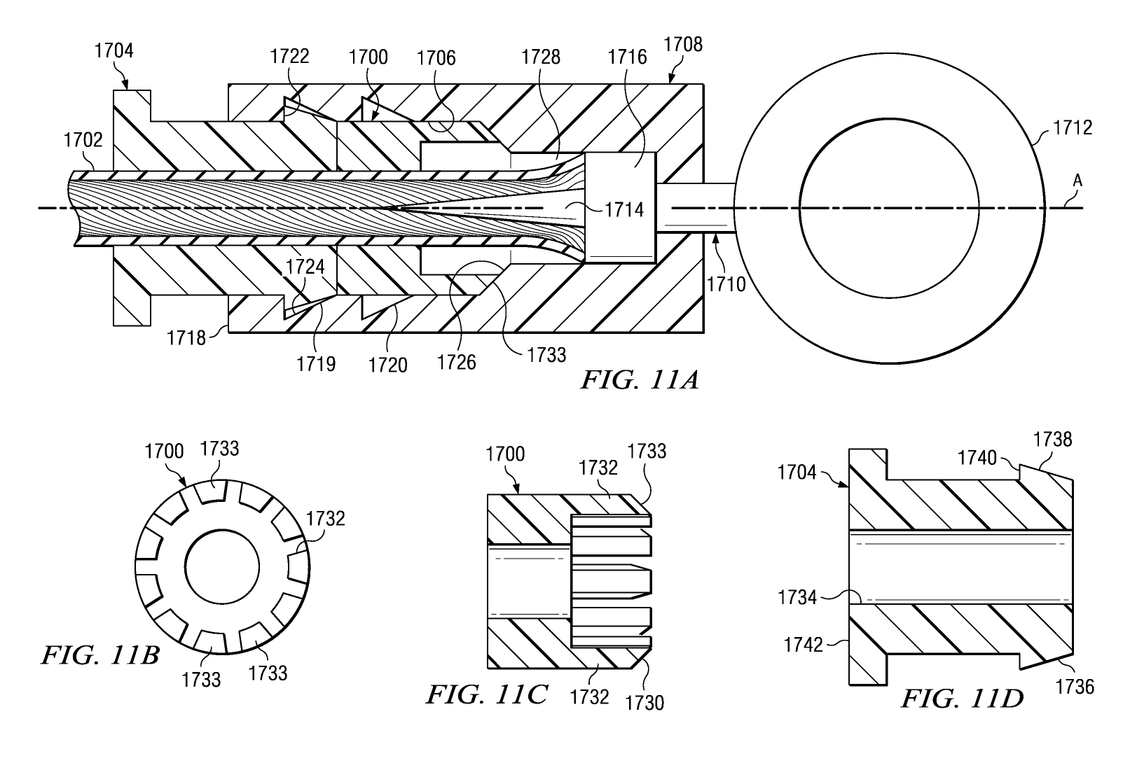

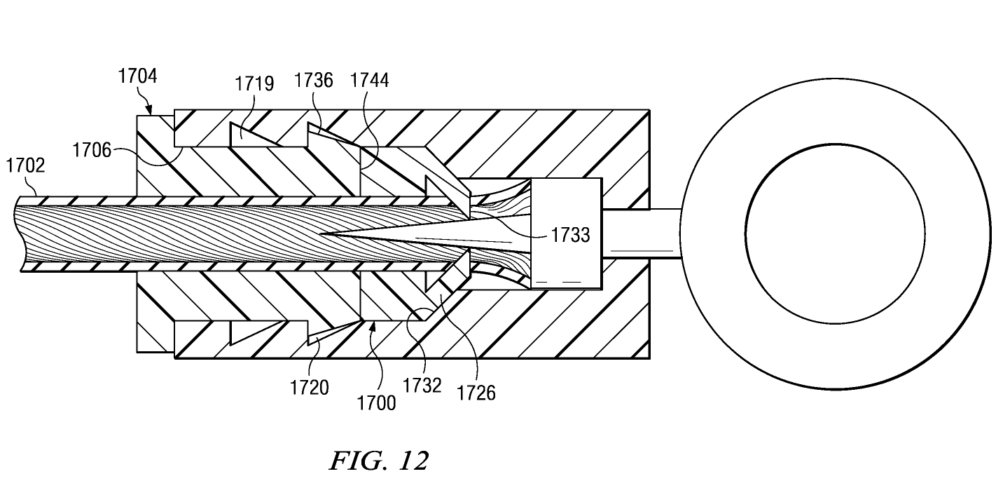

In the embodiments shown in FIGS. 11A-13B, a collar 1700 is provided as an additional component. Referring particularly to FIGS. 11A-12, the collar 1700 performs the function of firmly fastening the multistranded conductor 1702, while a cap 1704 acts as a “pusher” to advance the collar 1700 from an initial position inside a bore 1706 of a female connector body 1708 to a final position therein.

The connector body 1708 has a conductive element 1710, one end 1712 of which can be an annulus but which can also be formed as a spade, pin, banana plug or the like. The other end of the conductive element is a center pin 1714 which axially outwardly extends into the body bore 1706 from a base 1716 thereof. The center pin 1714 can be conical, as shown, or can take other convenient shapes such as others illustrated in this specification for other embodiments.

The female connector body 1708 has an outer axial end 1718 on which bore 1706 opens. The bore 1706 is provided with first and second preferably circumferential grooves 1719, 1720 which are axially displaced from one another. It is preferred that each groove 1718, 1720 be formed by a differential surface pair. By way of example, the axially outward groove 1719 has a leading surface 1722 with a relatively small surface area, and can take the form of an annulus or step at right angles to an axis A of the connector. A trailing surface 1724 of the groove 1719 has a relatively large surface area in comparison to leading surface 1722, and can be frustoconical in shape.

At a position which is axially inwardly displaced from the grooves 1719, 1720, the bore 1706 has a surface 1726 which slopes radially and axially inwardly. Surface 1726 can be frustoconical or frustopyramidal, and can have a straight profile in axial section, as shown, or can take a convexly or concavely curved profile. The bore 1706 finishes in a section 1728 of much smaller cross section than its remainder.

The collar 1700 preferably has a cylindrical bore that permits the introduction therethrough of the conductor 1702. Collar 1700 will in general have diameter which is a little smaller than the diameter of the bore 1706. A front end 1730 of the collar 1700 is divided into a plurality of axially extending fingers 1732 which initially are spaced apart from each other. It is preferred that each finger 1732 terminate in a radially inwardly beveled or chiseled edge 1733. The collar 1700 precedes the cap 1704 inside the female connector body bore 1706.

The last component of this embodiment is the cap 1704 (FIG. 11D), which has an internal bore 1734 that permits the threading of the conductor 1702 therethrough. The cap 1704 has a generally cylindrical outer surface with a ridge 1736 thereon which extends radially outwardly from the generally cylindrical outer surface. Preferably, the ridge 1736 is formed with a differential surface pair: a leading surface 1738 has more surface area than a trailing surface 1740. Surface 1740 can be formed as an axially orthogonal annulus, as shown, while leading surface 1738 can be frustoconical. An outer axial end 1742 can be enlarged so as to receive a compression tool.

A first stage of conductor-connector assembly is shown in FIG. 11A. The user has threaded the cap 1704 and then the collar 1700 onto the free end of a conductor 1702 to be connected. Next, the user inserts the conductor 1702 into the bore 1706 of the connector body 1708 and impales the conductor 1702 onto the center pin 1714. The user then inserts the collar 1702 into the bore 1706 until resistance is encountered and snaps the cap 1704 into a first position, in which the ridge 1736 thereof is in registration with axially outward groove 1719. Alternatively, the connector body 1708 can come to the user in a condition in which, preassembled to it, are collar 1700 and cap 1704 in a first, axially outward position as shown.

A second, final stage of assembly is shown in FIG. 12. The cap 1704 is advanced into bore 1706 such that ridge 1736 leaves groove 1719 and comes instead into registration with groove 1720. A front end 1744 of the cap 1704 pushes the collar 1700 axially inwardly. As this happens, beveled surfaces 1733 of collar fingers 1732 begin to cam inwardly on sloped surface 1726 of bore 1706, forcing the fingers inwardly into contact with conductor 1702. The fingers 1732 can be designed to be long and can be sharpened, so as to intentionally pierce the insulation as shown, or they can instead be shorter and blunter so as to only the grip the insulated external surface of the conductor 1702. The fingers 1732 will in any event firmly affix the conductive strands of the conductor 1702 to the center pin 1714.

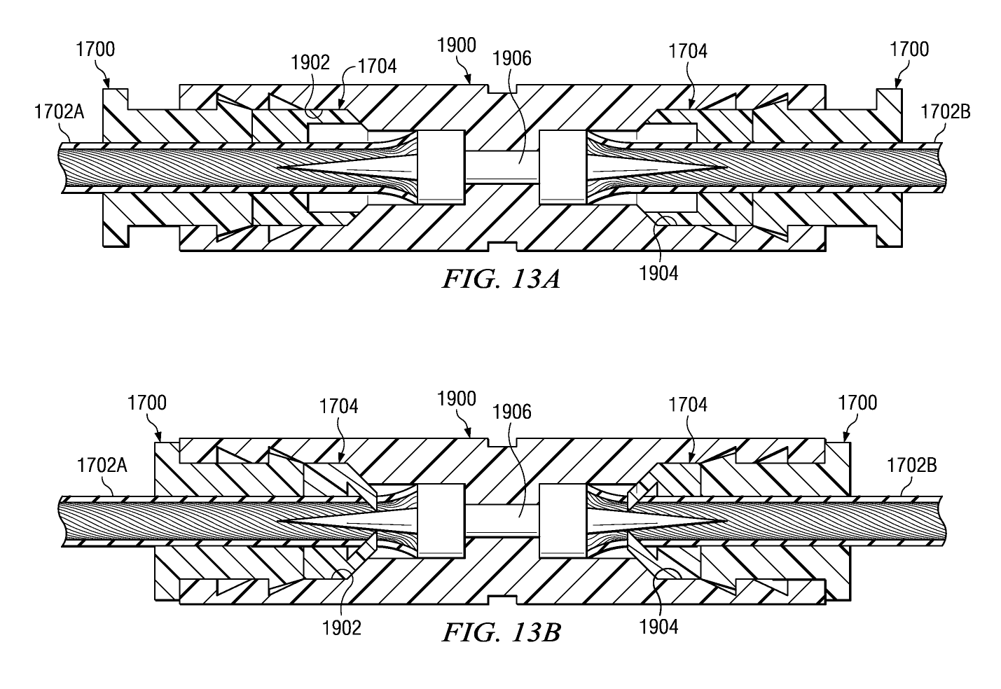

FIGS. 13A-13B illustrate a variation on the embodiment shown in FIGS. 8A-12, in the form of an in-line connector. A body 1900 has two bores 1902, 1904, each similar to bore 1706. A center pin 1906 extends from bore 1902 to bore 1904 so as to provide conductive connection therebetween. Each bore 1902, 1904 is provided with a cap 1700 and a collar 1704, the structure and function of which are the same as in the embodiments described in FIGS. 8A-12. FIG. 13A illustrates an initial stage in the in-line connection of conductor 1702A to a conductor 1702B, while FIG. 13B illustrates a final stage thereof.

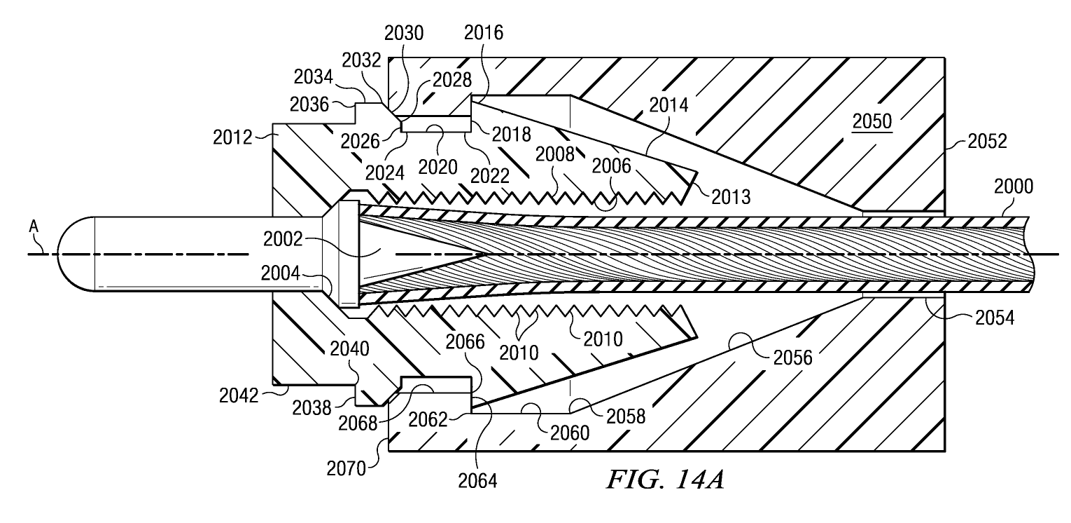

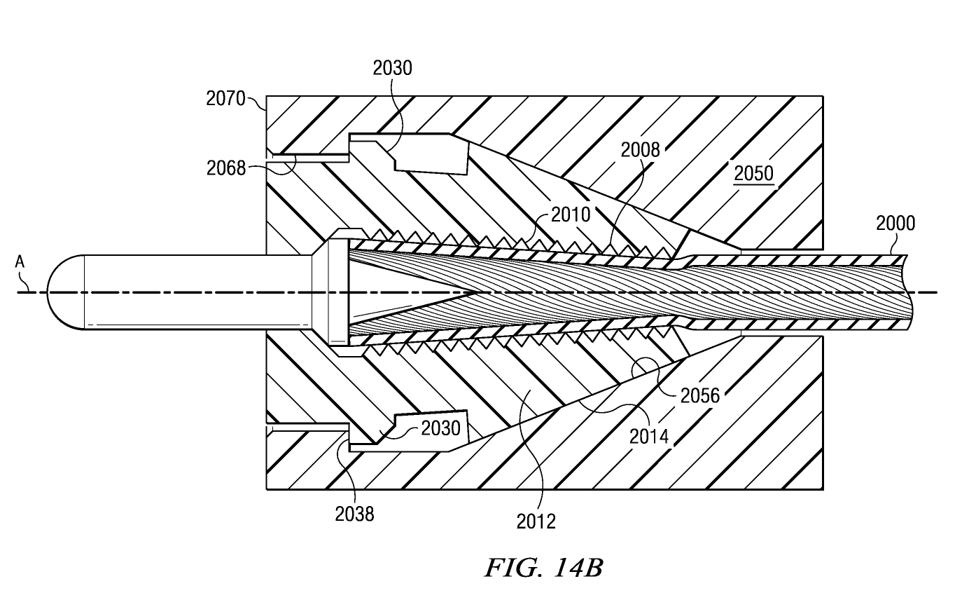

In the embodiment shown in FIG. 14A, an end of a preferably insulated conductor 2000 has been impaled onto a conical center pin 2002. The center pin 2002 extends axially outwardly from the base 2004 of a bore 2006, a substantially cylindrical sidewall 2008 of which has been provided with threads, knurls or other friction-providing surfaces 2010. However, as uncompressed, the internal diameter of the bore 2006 does not impede the insertion of the conductor 2000 all of the way on to the center pin 2002.

The bore 2006 is formed in a female connector body 2012. An external outer surface of body 2012 preferably has at least four zones. At an axially outward end 2013 there begins a first sloped surface 2014, which has a small diameter at end 2013 but which has a larger diameter at the inward end 2016 of the surface 2014. The surface 2014 can be straight in axial cross section as shown, or can be convexly or concavely curved, as has been explained in conjunction with other embodiments herein. At point 2016 there begins a first step surface 2018, which as illustrated can be annular and can be at right angles to the axis A.

The step surface 2018 proceeds radially inwardly for a short distance until it meets surface or land 2020. The surface 2020 is substantially cylindrical and can have a uniform diameter from its outer axial end 2022 to an inner axial end 2024 thereof.

A second step surface 2026 proceeds axially outwardly from point 2024 to a point 2028. At point 2028, a beveled or sloped surface 2030 starts and proceeds radially outwardly and axially inwardly to point 2032. Surface 2030 may for example be frustoconical and, in an alternative embodiment, can begin at point 2024, such that step surface 2026 is omitted.

A further cylindrical surface 2034, at a uniform diameter, extends axially inwardly from point 2032 to a point 2036. A radially inwardly extending step surface 2038 extends from point 2036 to a point 2040. A cylindrical land 2042 extends axially inwardly from point 2040 for at least a substantial distance.

The body 2012 is used in connection with a cap 2050. At its outer axial end 2052, a central bore 2054 is provided to accept therethrough the conductor 2000 to be connected. At a point axially inward from the end 2052, a sloped surface 2056 begins. This sloped surface extends axially inwardly and radially outwardly to a locus 2058. The length of the surface 2056 should be at least as long as the length of body surface 2014. When the diameter of point 2016 is reached, the cap sloped surface 2056 may end and the internal cavity of cap 2050 may start to be defined by a cylindrical surface 2060.

The cylindrical surface 2060 proceeds axially inwardly until a point 2062, at which a step surface 2064 extends radially inwardly to a point 2066. A ridge 2068 begins at point 2066 and extends axially inwardly therefrom until an inner end 2070 of the cap 2050 is reached.

In a first stage of assembly of the conductor 2000 to this connector, the step surface 2064 abuts the body surface 2018, and the corner or end 2070 of the cap rides on the beveled surface 2030. The user then pushes the cap 2050 axially inwardly until the configuration shown in FIG. 14B is reached. When this happens, sloped surface 2056 starts camming against connector body surface 2014, eventually compressing the frictional elements 2010 of bore 2008 into the insulation of conductor 2000. While this is happening, the ridge 2068 of cap 2050 rides over the beveled surface 2030 and surface 2034, to snap past body step surface 2038.

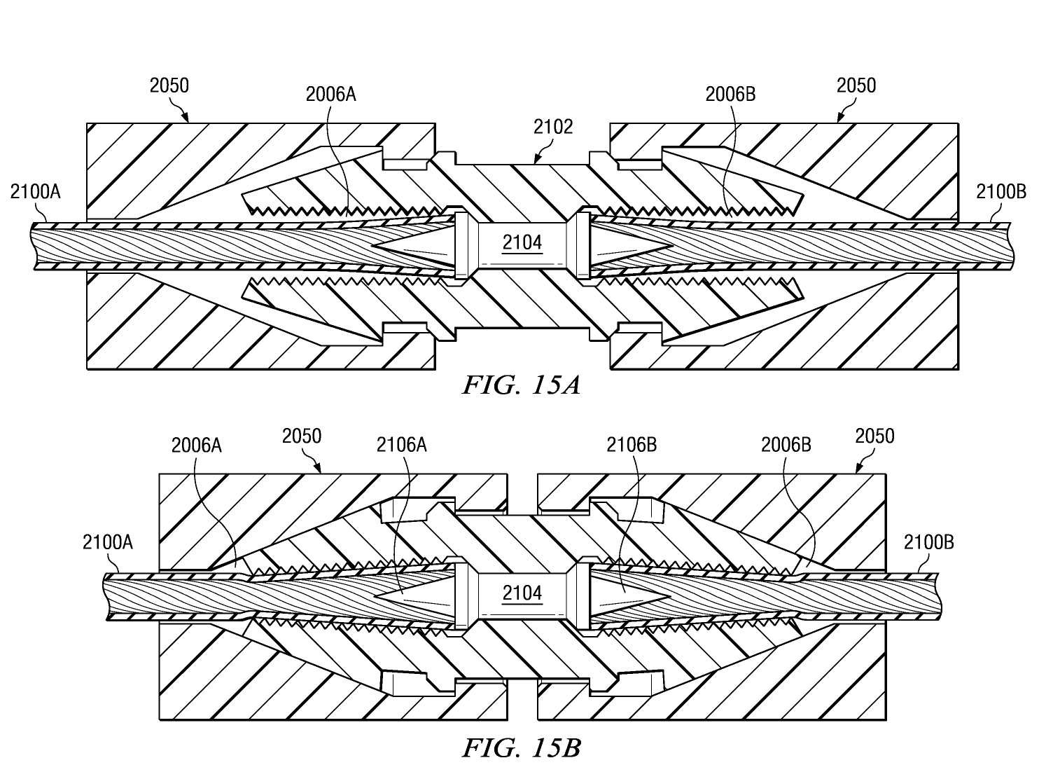

FIGS. 15A and 15B show first and second stages of assembly of one conductor 2100A in line to another conductor 2100B. Two bores 2006A and 2006B are formed in a unitary body 2102, and these are otherwise identical in structure and function to bore 2006 in the embodiment shown in FIGS. 14A and 14B. A unitary pin 2104 has opposed conical ends 2106A and 2106B. A cap 2050 is provided for each bore 2006A, B and their construction and function are the same as that for cap 2050 in FIGS. 14A and 14B.

FIGS. 16A-18B illustrate a further embodiment similar to that shown in FIGS. 8A-10B. In this embodiment, a female connector body 2200 (FIG. 17) has a conductive center pin 2202 which is aligned with an axis A of the body 2200. It is preferred to mold or otherwise fabricate the body 2200 from an insulative material. The conductive center pin, which for example may be brass, has an inner axial end 2204 which is shown as a simple cylinder, but which can take other forms, such as spades, annular terminals, lugs or other common types—or could be threaded to receive any one of these.

The “outer” axial end 2226 of the center pin 2202 is pointed and is upstanding from a floor or bottom 2206 of a female connector body bore 2208. The body 2200 has an axial passage 2209 from its end 2210 to the bottom 2206 which closely fits the side of a shaft 2212 of the center pin 2202. The center pin 2202 has a radial enlargement 2214 which occupies a countersunk bore 2216 in the body 2200, such that the enlargement substantially occupies the countersunk bore 2216 and creates a bore floor 2218.

Pin 2202 terminates in an axially outward direction in a conical shape 2220. The base of the conical shape 2220 is radially inwardly stepped from the diameter of the pin enlargement 2214. This radial inward step is sized to accommodate the ends of the gores of a connecting cap (see FIGS. 16A-16C), and the end of an impaled multistranded wire to which connection will be made, as will be explained below.

While in one embodiment the conical shape 2220 may be uninterrupted, in this embodiment the pin end 2220 has a pair of grooves 2222, 2224 machined into its conical surface. The grooves are spaced from the floor 2218 in an axially outward direction and from each other but are spaced axially inwardly from a tip 2226 of the cone 2220.

A sloped surface or surfaces 2228 extends axially outwardly (here, in a downward direction) and radially outwardly for a distance which, as measured axially, is greater than the displacement of the grooves 2222, 2224 from the floor 2218. The sloped surface 2228 can for example be frustoconical or conform to another surface of rotation, or could be a multi-sided frustopyramid. The illustrated embodiment in particular is a frustoconical surface at an angle β to the axis A, which can for example be chosen as about 50°. The conical shape 2220 of the center pin 2202 is preferably chosen to be at an angle γ to the axis which is substantially smaller than this, such as 8.5°.

The frustoconical surface 2228 extends axially and radially outwardly to a locus 2230, at which locus begins an inner connecting groove 2232 for accepting a ridge of a cap. The groove 2232 preferably is composed by at least two surfaces: a first surface 2234, formed at an angle to axis A, and a second surface 2236, formed axially outwardly from first surface 2234 and to have a smaller surface area than first surface 2234. Surface 2234 may, for example be frustoconical and surface 2236 may be an annulus. There may be a small right cylindrical surface 2238 in between the surfaces 2234 and 2236. While the preferred differential surface pair 2234, 2236 take the form of a frustoconical surface and an annulus, and are straight in axial section, the surfaces 2234, 2236 alternatively could be concavely or convexly curved.

Axially outwardly from the first groove 2232, the sidewall of the bore preferably takes a cylindrical shape until a second, axially outward groove 2240 is encountered. The morphology of groove 2240 may be similar to that of groove 2232 and preferably is formed by another differential surface pair; preferably, groove 2240 is displaced radially outwardly from axis A by a larger amount relative to the radial displacement of inner groove 2232. This makes entering and leaving groove 2240 by a cap ridge easier. The axial distance between grooves 2232 and 2240 should be at least as great as the axial depth of the frustoconical surface 2228.

The inner end 2210 of body 2200 is preferably a flat disk and can accept one face of a compression tool. An outer end 2242 of the body 2200 is also conveniently fashioned as a right annulus and is adapted to receive an enlarged end of a cap, as will be described below.

A first cap 2250 for use with female connector body 2200 is shown in FIGS. 16A and 16C, and a second cap 2252 is shown in FIG. 16B. Caps 2250, 2252 are identical except for the diameters of their interior bores 2254, 2256, which are different from each other and are sized to closely receive stranded conductors of particular diameters or ranges thereof. In a commercial embodiment, at least four different caps can be provided to the user in a connection kit with the female connector body 2200; only a representative two are shown here.

Most of the external surfaces of caps 2250, 2252 are formed by a cylindrical (or, alternatively, prismatic) surface 2258, made to be parallel to the axis A and sized and shaped to be slidably received into the axially outward portion of bore 2208 of the female connector body 2200 (FIG. 17). An outer (in FIGS. 16A-C, upper) end 2260 of cap 2250 has an enlargement that can for example receive one jaw of a compression tool (not shown).

The sidewalls 2262 of the caps 2250, 2252 are interrupted into a plurality of circumferentially spaced-part gores 2264. As one proceeds axially inwardly (downward in FIGS. 16A-16C) each gore 2264 occupies less of a radial angular segment, and also becomes less thick. Because of this diminution the gores 2264 define in between them a roughly conical space with an axially inward base.

In this embodiment each cap 2250, 2252 is provided with one ridge 2266 on its general exterior cylindrical surface 2258. The ridge 2266 preferably is formed as a differential surface pair, with a leading surface 2268 having more surface area than a trailing surface 2270. Leading surface 2268 here is shown as a frustoconical surface. Trailing surface 2270 can be an annulus at right angles to axis A. Other differential surface pairs, consisting of or comprising convexly or concavely surfaces, could be substituted for the sectionally straight surfaces shown here.

While in some embodiments the ridge 2266 is circumferentially endless, in this illustrated embodiment the ridge 2266 has been interrupted in four places by spaces 2272 (one shown), which are used to create the gores 2264. The ridge 2266 should be located on a portion of the cap 2250, 2252 which will not radially inwardly collapse when camming up against surface 2228 under axial compression. It is preferred to place the ridge 2266 at a distance from enlargement 2260 which is at least as much as the axial separation of grooves 2232, 2240 (FIG. 17A) plus the distance between outer groove 2240 and female body outer end 2242.

In axial sectional view (FIGS. 16A and 16B), a radially inward surface 2274 of the cap 2250 conforms in a general way to a conical surface at an angle α. Preferably angle α is chosen to be about the same as angle β of the female connector body 2200 (FIG. 17). This is so that, the conical volume of conductive cone 2220 neglected, the volume occupied by collapsed gores 2264 plus the volume of the conductor itself will be similar to the volume occupied by the frustoconical inner portion of bore 2208. But preferably the inward surface is not smooth, but rather has a plurality of conductor-gripping ridges or teeth 2276. Even more preferably, a number of the ridges 2276 of the cap 2250 or 2252 are so disposed along the gore inner surface that they will register with respective grooves 2222, 2224 of the center pin 2202, crimping the conductor strands between them.

The material of caps 2250, 2252 is preferably an insulator in this embodiment, and even more preferably is a resilient and tough polymer that can undergo some deformation without splitting or tearing. A polytetrafluoroethene (PTFE) compound sold under the mark DURLON® by Triangle Fluid Controls of Belleville, Canada is particularly preferred.

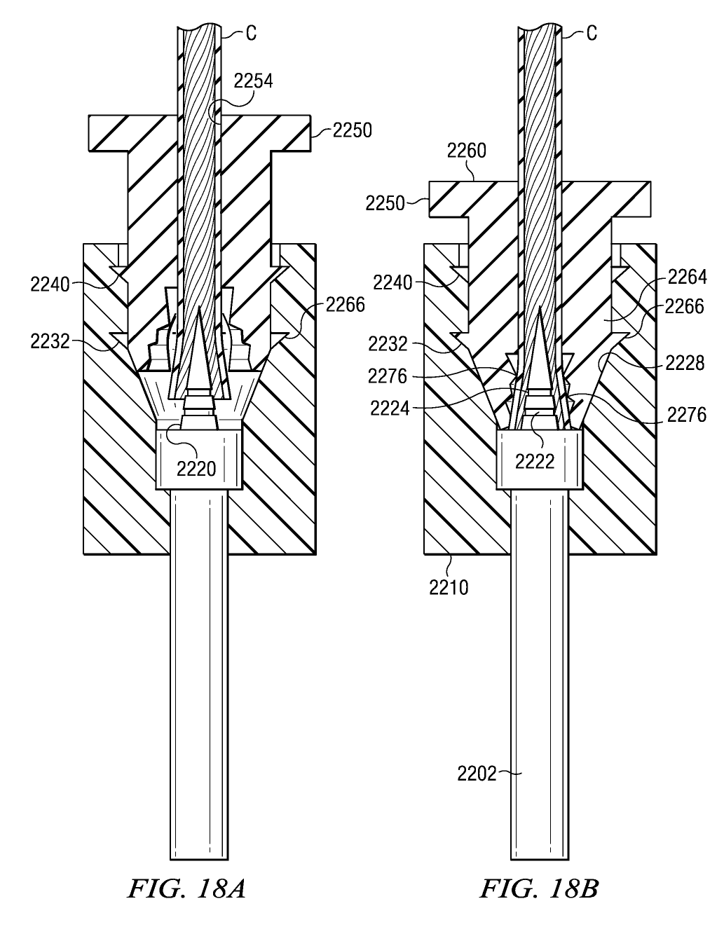

FIG. 18A shows a first stage in using the embodiment shown in FIGS. 16A-17A to connect to a multistranded conductor. First, a cap 2250 is selected among several such provided to fit the external diameter of a conductor C to be connected. The end of conductor C is threaded through the internal bore 2254 of the cap 2250 and impaled on center pin conical portion 2220 of the female conductor body 2200. The conductor C may be inserted through cap bore 2254 while the cap bore is in a first detented position in female connector body bore 2208, defined by outer groove 2240. In the first position the ridge 2266 of the cap 2250 is disposed in the outer groove 2240.

A second and final stage of connection is shown in FIG. 18B. Preferably a plier-like compression tool (not shown) exerts compressive force on surfaces 2260 and 2210, advancing cap 2250 from the first position defined by outward groove 2240 to a second, axially inward position defined by inner groove 2232. As this is happening the gores 2264 cam against frustoconical end surface 2228, forcing the gores 2264 radially inwardly such that their teeth 2276 grip the outer insulation of the conductor C and fasten conductor C firmly to the conductive center pin 2202.

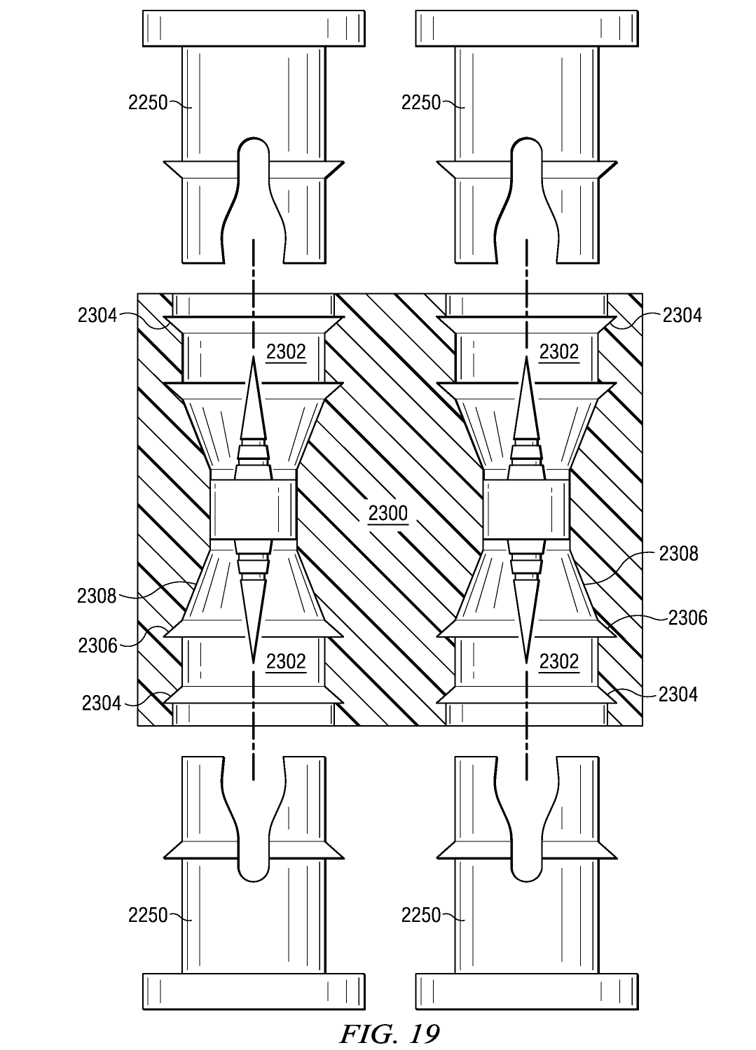

Variations on this embodiment are illustrated in FIGS. 19-24. In FIG. 19, a multiconductor connector 2300 is provided with four female connector body bores 2302, each of which receives a separate cap 2250. Each of the bores 2302 has an axially outward groove 2304 and, spaced therefrom, an axially inward groove 2306. A sloping end surface 2308 forming a portion of each bore 2302 is not a frustoconical surface but rather a concave surface of rotation.

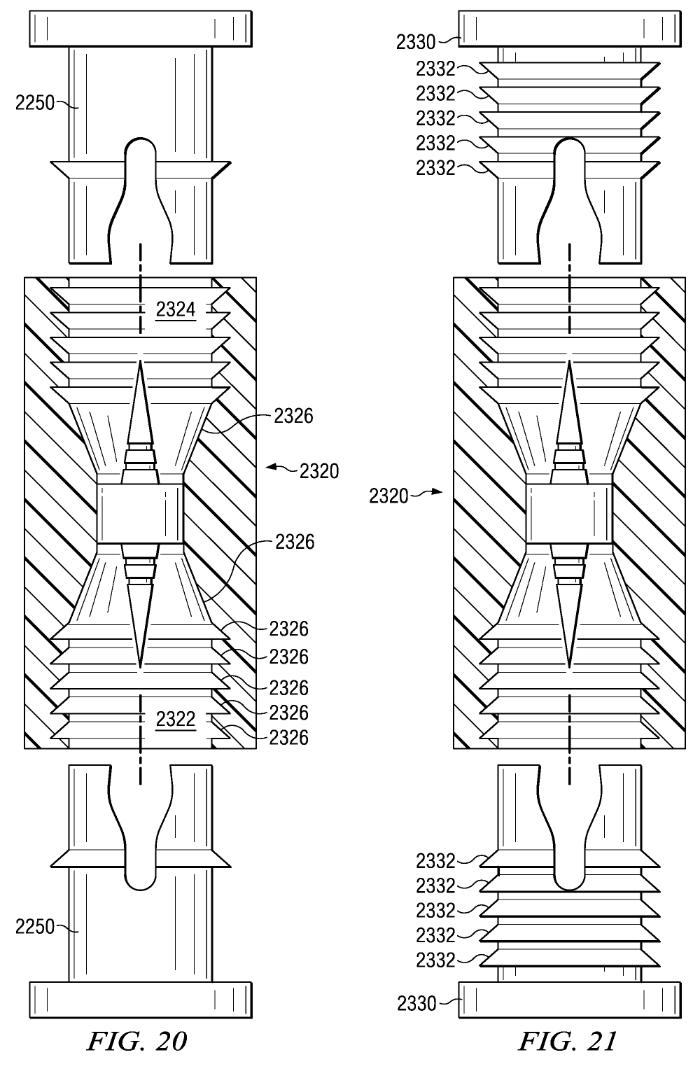

In FIG. 20, an in-line splice connector body 2320 has two bores 2322, 2324, each with respective sloped camming inward end surfaces 2326. An axially outer section of each bore 2322, 2324 has a sidewall with more than two grooves in it (in this illustrated embodiment, five), defining five different positions which can be occupied by the cap 2250. These multiple grooves 2326 permit more variation in conductor size and firmness of connection.

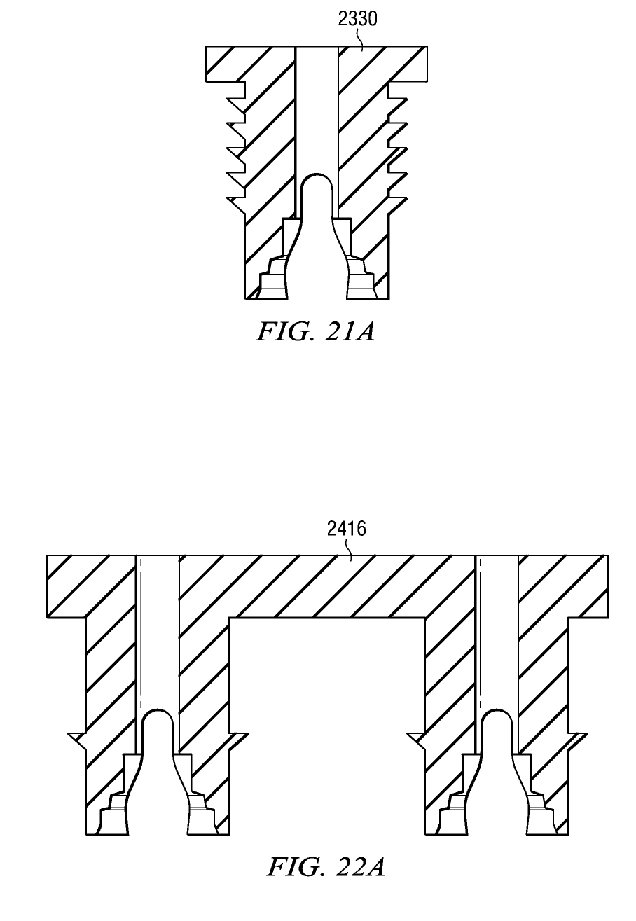

FIGS. 21 and 21A illustrate an embodiment in which the in-line splice connector body 2320 is the same as that shown in FIG. 20, but in which each of two caps 2330 have more than two ridges 2332 (in this illustrated embodiment, five). A multiply ridged cap can be used in those situations in which the bore has a number of grooves that has the same or a larger number of grooves. As each additional ridge 2332 is engaged, the connection is made physically more robust.

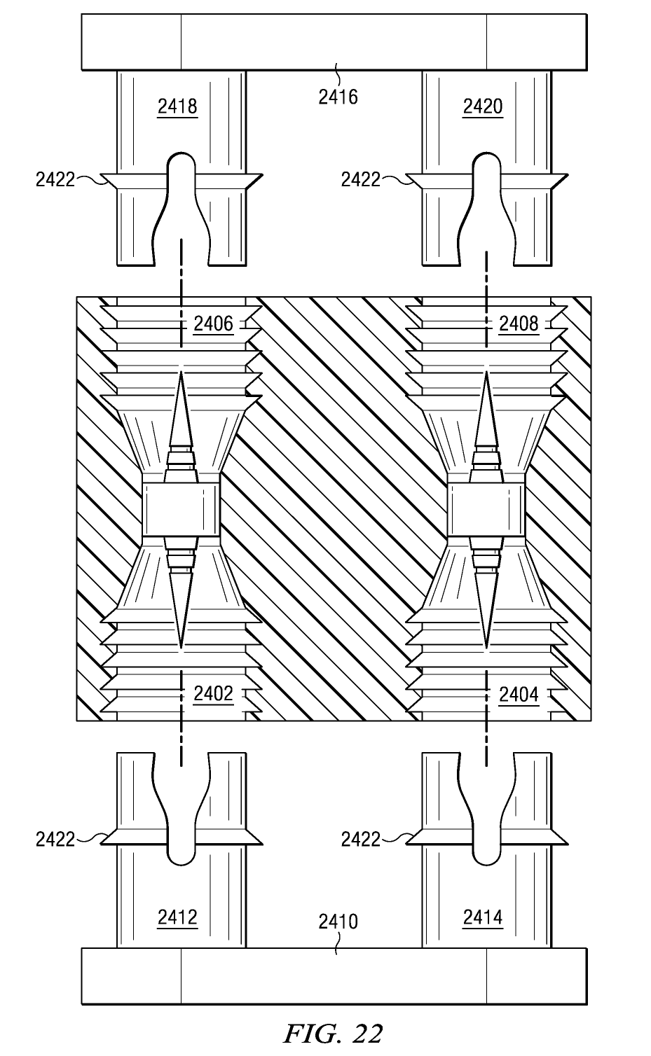

FIGS. 22 and 22A illustrate an embodiment in which a multiple-connector body 2400 has four bores 2402-2408, each with five, axially spaced-apart grooves 2404 that each define a separate axial position for an inserted cap. A multiple cap 2410 has a first portion 2412 which is inserted into bore 2402 and a second portion 2414 which is inserted into bore 2404. A second multiple cap 2416 has a first portion 2418 which is inserted into bore 2406 and a second portion 2420 which is inserted into bore 2408. Each of the cap portions 2412, 2414, 2418, 2420 has a single interrupted ridge 2422.

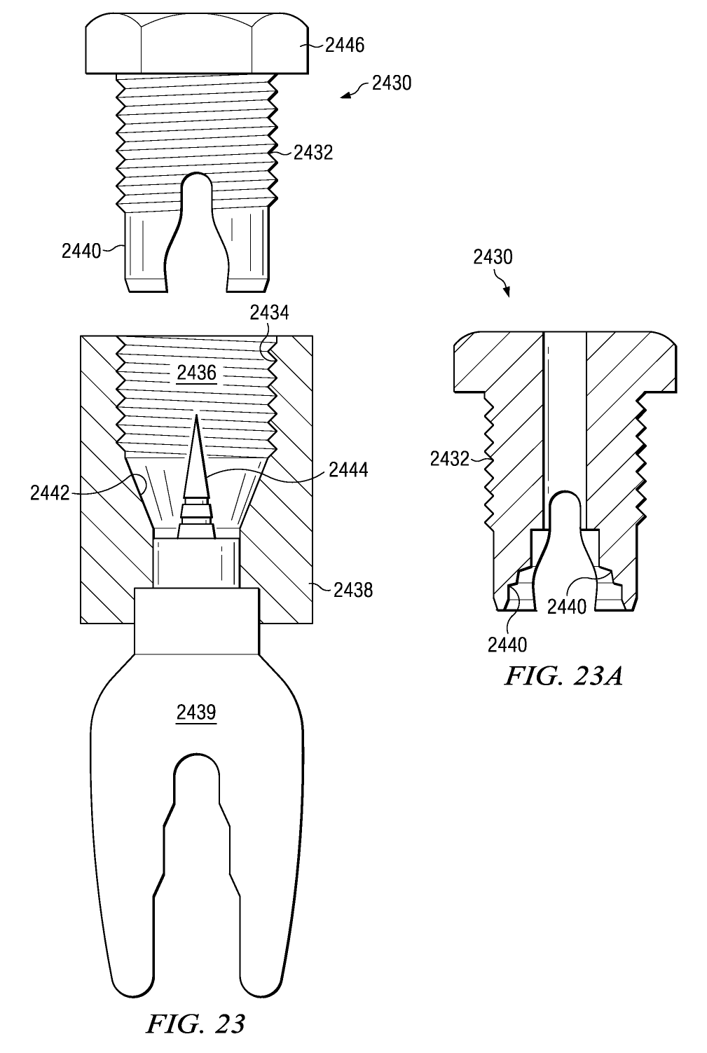

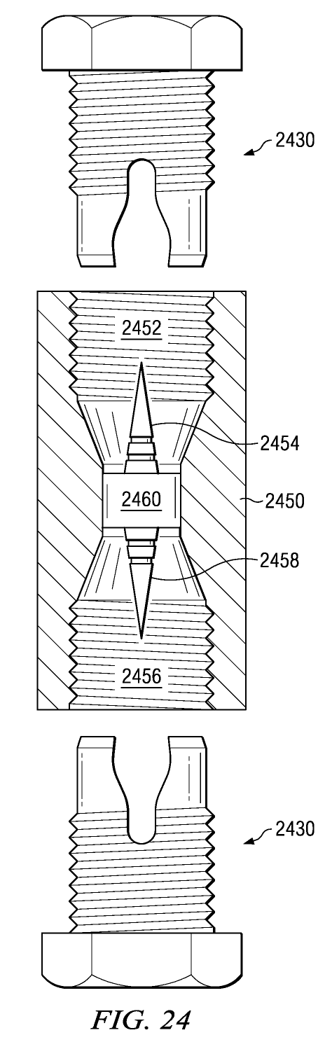

The embodiments shown in FIGS. 23-24 differ from the ones immediately above in that the cap 2430 has male threads 2432 that are designed to mate with female threads 2434 in a bore 2436 of a connector body 2438. These embodiments can be provided for uses such as battery terminals; the illustrated connector body 2438 (FIG. 23) includes a conductive spade connector element 2439. The cap 2430 can be made of a conductor such as brass. Cap 2430 continues to have gores 2440 which, when they cam against sloped end surface 2442 of the bore 2436, will radially inwardly collapse, gripping the conductor (not shown) which had been previously threaded through cap 2430 and impaled onto center pin 2444. The gores 2440 can either have sharpened edges designed to cut through the insulation of the conductor, or can terminate in nonsharpened edges which will merely grip the insulated external surface of the conductor. An enlargement 2446 on an axially outer end of the cap 2430 can have a hex shape or otherwise furnish wrench-engaging surfaces for twisting the cap 2430 into the bore 2436.

The in-line splice connector embodiment shown in FIG. 24 is similar in most of its structure to that shown in FIG. 23. A female connector body 2450 has a first bore 2452 with a first upstanding grooved conical center pin 2454 on its axis, and a second bore 2456 with a second upstanding grooved conical center pin 2458 on the axis of bore 2456. The center pins 2454, 2456 are conductively connected together and preferably are portions of a unitary conductive element 2460.

It should be understood that various features and modifications shown in only one or some of the illustrated embodiments can be easily adapted to the others. Any of the illustrated embodiments (except for the ones shown in FIGS. 23-24) can take on a prismatic or oval rather than a cylindrical form, and can even have irregular but substantially axially uniform cross-sections. Any of the illustrated connectors may be formed all of metal or alternatively may be largely constituted by injection-molded plastic. Most of the embodiments are suitable for connecting to uninsulated as well as insulated multistranded wire. All can be furnished in a preassembled condition to end users, usually with their caps snapped to first, axially outward positions, or alternatively can be furnished with a cap and physically separate connector body. The connectors according to the invention may be furnished singly or multiply, and may be joined together as might occur where a terminal block or wiring harness has several connector body bores.

O-rings may be furnished in any of the embodiments for sealing an axially outward cap end to the connector body, and/or for sealing the inner bore of the cap to the insulation of the conductor. All illustrated connector bodies may be furnished with only one, or more than two, detenting grooves. All embodiments may be manufactured in end-to-end or Y-conductor splicing forms. The described detenting grooves and ridges can be formed by surfaces other than annuluses and frustoconical surfaces. Connectors may be provided according to the invention in which one or more grooves are provided on the cap and one, two or more detenting ridges are provided on the sidewall of the connector body bore, in mirror image to those described. All embodiments may be provided with discontinuous instead of endless grooves and ridges, and these grooves and ridges may even include several, physically separate segments at each axial position. The conductor supplied with the connector(s) may have its insulation marked along its length to indicate a correct amount of insertion into the connector. These modifications are all within the scope of the disclosed invention.

In summary, different embodiments of a compression snap electrical connector have been shown and described, wherein gores of a cap cam against a bottom sloped surface in the connector body bore to effect connection to the conductor. While various embodiments of the present invention have been described above and illustrated in the appended drawings, the present invention is not limited thereto but only by the scope and spirit of the appended claims.

I claim:

1. An electrical connector, comprising:
a connector body having a bore with an axis and an open end, the bore having a sidewall generally parallel to the axis and extending generally axially inwardly from the open end toward an inner end of the bore, a radially inwardly and axially inwardly sloping surface extending from the sidewall to the inner end of the bore; and
a cap having an inner axial end and an outer axial end and having a cavity from the outer to the inner axial ends for accepting a conductor therethrough, an outer surface of the cap including a general outer surface substantially parallel to the axis and adapted to be slidably received into the bore of the connector body;
the inner axial end of the cap terminating in a plurality of spaced-apart gores, the gores, when the cap is advanced into the bore of the connector body, camming against said sloping surface of the bore so as to radially inwardly collapse toward the axis of the connector body, the gores then grasping an external surface of a conductor threaded through the cap in order to electrically connect the conductor to the connector.

2. The electrical connector of claim 1, further comprising means disposed on the cap and in the bore to affix the cap to the connector body such that the gores remain cammed against the sloping surface of the bore and such that the gores continue to grasp the external surface of the conductor.

3. The electrical connector of claim 2, wherein said means comprise
at least one groove disposed on a first one of the sidewall of the connector bore and said outer surface of the cap, and
at least one ridge disposed on a second one of the sidewall of the connector bore and said outer surface of the cap, the ridge adapted to be received within the groove to fasten the cap to the connector body.

4. The electrical connector of claim 3, wherein said at least one groove has a first surface and a second surface formed axially outwardly from the first surface, the first and second surfaces formed at an angle to the axis, an area of the first surface being substantially greater than an area of the second surface; and wherein said at least one ridge has a leading surface and a trailing surface formed axially outwardly from the leading surface, an area of the leading surface being substantially greater than an area of the trailing surface.

5. The electrical connector of claim 4, wherein at least one of the first surface of the groove and the leading surface of the ridge is a beveled surface.

6. The electrical connector of claim 4, wherein said at least one groove is endless.

7. The electrical connector of claim 4, wherein at least one of the second surface of said least one groove and the trailing surface of the ridge is formed to be substantially orthogonal to the axis.

8. The electrical connector of claim 3, wherein a plurality of grooves, axially spaced apart from each other, are disposed on said first one of the sidewall of the connector bore and said outer surface of the cap.

9. The electrical connector of claim 3, wherein a plurality of ridges, axially spaced apart from each other, are disposed on said second one of the sidewall of the connector bore and said outer surface of the cap.

10. The electrical connector of claim 3, wherein said first one of the sidewall of the connector bore and said outer surface of the cap is the sidewall of the connector bore.

11. The electrical connector of claim 2, wherein said means for affixing comprises threads on the outer surface of the cap and on the sidewall of the bore.

12. The electrical connector of claim 1, wherein the gores of the cap are made of a malleable material selected from the group consisting of plastic and metal.

13. The electrical connector of claim 1, wherein the gores of the cap are spaced apart from each other by openings having a width which varies in an axial direction, the openings becoming smaller as a function of the distance from the inner axial end of the cap.

14. The electrical connector of claim 1, wherein each gore of the cap, when taken in axial section, has a radially inwardly facing internal surface which, when viewed in axial section, is substantially at a first predetermined angle to the axis.

15. The electrical connector of claim 14, wherein the sloped surface at the inner end of the bore of the connector body is at a second predetermined angle to the axis, the second predetermined angle being substantially similar in magnitude to the first predetermined angle.

16. The electrical connector of claim 1, wherein the sidewall of the bore of the connector body is generally cylindrical.

17. The electrical connector of claim 1, wherein each gore has an internal surface facing the cavity of the cap, the internal surface of each gore having at least one inwardly projecting gripping ridge; and
the connector body further including a center pin extending axially outwardly from the inner end of the bore and ending in a tip, the center pin having a sidewall, at least one circumferential groove disposed in the sidewall of the center pin.

18. An electrical connector for connecting to a conductor, comprising:
a connector body having a bore with a general inner diameter, an open end and a bottom, a center pin extending axially outwardly from the bottom into the bore;
a sloping surface formed in the bore and extending radially and axially inwardly from the general inner diameter toward the bore bottom;
a collar having a bore for accepting the conductor therethrough, an axial inner end and an axial outer end, a plurality of spaced-apart fingers forming the last said inner end, the collar sized to fit within the general inner diameter of the body bore;
a cap having an inner axial end and an outer axial end, the cap having an general external diameter which is smaller than the general inner diameter of the bore body,
the conductor impaled on the center pin, the cap advancing axially inwardly in said body bore so that the cap pushes the collar axially inwardly such that the fingers of the collar cam against said sloping surface of the bore, said fingers then grasping an external surface of the conductor to affix the connector to the conductor.

19. The electrical connector of claim 18, and further comprising means disposed on the cap and in the bore to affix the cap to the connector body such that the fingers of the collar remain cammed against the sloping surface of the bore and such that the fingers continue to grasp the external surface of the conductor.

20. The electrical connector of claim 19, wherein said means comprises
at least one groove disposed on a first one of the sidewall of the connector bore and said outer surface of the cap, and
at least one ridge disposed on a second one of the sidewall of the connector bore and said outer surface of the cap, the ridge adapted to be received within the groove to fasten the cap to the connector body.

21. A kit for connecting to one of a plurality of electrical conductors having different diameters, comprising:
a connector body having a bore with an axis and an open end having a first internal diameter, the bore having a sidewall extending generally axially inwardly from the open end toward an inner end of the bore, a radially inwardly and axially inwardly sloping surface extending from the sidewall to the inner end of the bore; and
a plurality of caps, each cap having an inner axial end and an outer axial end and having a cavity from the inner to the outer axial ends for accepting a conductor therethrough, an outer surface of each cap including a general outer surface substantially parallel to the axis and having a diameter less than said first internal diameter of the bore of the connector body;
the inner axial end of the cap terminating in a plurality of spaced-apart gores, the gores, when the cap is advanced into the bore of the connector body, camming against said sloping surface of the bore so as to radially inwardly collapse toward the axis of the connector body, the gores then grasping an external surface of a conductor threaded through the cap in order to electrically connect the conductor to the connector;
a diameter of any one cap across the cavity thereof being different from a like diameter of any other of the caps, such that one of the caps can be selected by a user to best fit a conductor of a particular diameter.
